(19) United States
(12) Patent Application Publication
(10) Pub. No.: US 2025/0339772 A1
(43) Pub. Date: Nov. 6, 2025

(54) Object Interaction Method and Apparatus, Electronic Device, Computer-Readable Storage Medium, and Computer Program Product

(71) Applicant: Tencent Technology (Shenzhen) Company Limited, Shenzhen (CN)

(72) Inventor: Tianchi Yang, Shenzhen (CN)

(21) Appl. No.: 19/269,407

(22) Filed: Jul. 15, 2025

Related U.S. Application Data
(63) Continuation of application No. PCT/CN2024/089785, filed on Apr. 25, 2024.

(30) Foreign Application Priority Data
Jun. 28, 2023 (CN) 2023107812165

(51) Int. Cl. A63F 13/52; A63F 13/533; A63F 13/54; A63F 13/56

(52) U.S. Cl. CPC A63F 13/52; A63F 13/533; A63F 13/54; A63F 13/56

(57) ABSTRACT

Interaction techniques for virtual objects in a virtual environment are described herein. The techniques may include displaying a first virtual object and M second virtual objects in a virtual scene, where M is a positive integer greater than 1, the second virtual object is configured for outputting at least one note, and at least some notes outputted by different second virtual objects are different; displaying a process in which N second virtual objects output target notes, where N is a positive integer and N is less than or equal to M; controlling, in response to an interaction operation on the M second virtual objects, the first virtual object to interact with the M second virtual objects; and displaying an interaction result of the first virtual object with reference to an output sequence of the target notes and an interaction sequence of the first virtual object with the M second virtual objects.

### CROSS-REFERENCE TO RELATED APPLICATIONS

This application is a Continuation Application of PCT Application PCT/CN2024/089785, filed Apr. 25, 2024, which claims priority to Chinese Patent Application No. 202310781216.5, filed on Jun. 28, 2023, each entitled “OBJECT INTERACTION METHOD AND APPARATUS, ELECTRONIC DEVICE, COMPUTER-READABLE STORAGE MEDIUM, AND COMPUTER PROGRAM PRODUCT” and each of which is incorporated herein by reference in its entirety.

### FIELD

This application relates to the technical fields of virtualization and human-computer interaction, and in particular, to an object interaction method and apparatus, an electronic device, a computer-readable storage medium, and a computer program product.

### BACKGROUND

In a related game, when a player interacts with monsters, beating particular monsters generates audio information, and there is a reward for successful hitting. However, this interaction process of only relying on beating particular monsters to generate audio information results in a relatively single player interaction process. Consequently, human-computer interaction efficiency is excessively low, and hardware processing resources are caused.

### SUMMARY

Aspects described herein provide an object interaction method and apparatus, an electronic device, a computer-readable storage medium, and a computer program product, to improve diversity of an object interaction process in a virtual scene, human-computer interaction efficiency, and utilization of hardware processing resources.

Technical solutions of the aspects described herein are implemented as follows.

An aspect described herein provides an object interaction method, including:
displaying a first virtual object and M second virtual objects in a virtual scene,
where M is a positive integer greater than 1, the second virtual object is configured for outputting at least one note, and at least some notes outputted by different second virtual objects are different;
displaying a process in which N second virtual objects output target notes, where N is a positive integer and N is less than or equal to M;
controlling, in response to an interaction operation on the M second virtual objects, the first virtual object to interact with the M second virtual objects; and
displaying an interaction result of the first virtual object with reference to an output sequence of the target notes and an interaction sequence of the first virtual object with the M second virtual objects.

An aspect described herein provides an object interaction apparatus, including:
a first display module, configured to display a first virtual object and M second virtual objects in a virtual scene, where M is a positive integer greater than 1, the second virtual object is configured for outputting at least one note, and at least some notes outputted by different second virtual objects are different;
a second display module, configured to display a process in which N second virtual objects output target notes, where N is a positive integer and N is less than or equal to M;
a control module, configured to control, in response to an interaction operation on the M second virtual objects, the first virtual object to interact with the M second virtual objects; and
a third display module, configured to display an interaction result of the first virtual object with reference to an output sequence of the target notes and an interaction sequence of the first virtual object with the M second virtual objects.

An aspect described herein provides an electronic device, including:
a memory, configured to store computer-executable instructions; and
a processor, configured to implement, when executing the computer-executable instructions stored in the memory, the object interaction method provided in the foregoing aspect described herein.

An aspect described herein provides a computer-readable storage medium, having computer-executable instructions stored therein. The computer-executable instructions, when executed by a processor, implement the object interaction method provided in the foregoing aspect described herein.

An aspect described herein provides a computer program product or a computer program. The computer program product or the computer program includes computer-executable instructions. The computer-executable instructions are stored in a computer-readable storage medium. A processor of an electronic device reads the computer-executable instructions from the computer-readable storage medium. The processor executes the computer-executable instructions, to cause the electronic device to perform the object interaction method provided in the foregoing aspect described herein.

The aspects described herein have the following beneficial effects.

In the foregoing aspects described herein, after a first virtual object and M second virtual objects are displayed in a virtual scene, N second virtual objects are controlled to output target notes. Then, in response to an interaction operation on the M second virtual objects, the first virtual object is controlled to perform an interaction operation on the M second virtual objects. In this way, after a process in which the N second virtual objects output the target notes is displayed, the first virtual object is controlled to perform an interaction operation on the M second virtual objects, so that an interaction sequence of the first virtual object with the M second virtual objects is associated with a sequence in which the N second virtual objects output the target notes, thereby determining an interaction result based on the interaction sequence of the interaction operation and the output sequence of the target notes. In this way, the interaction result is not only related to the interaction operation, but also related to the interaction sequence of the interaction operation, thereby improving utilization and effectiveness of the interaction operation performed by the first virtual object, and also improving human-computer interaction efficiency and hardware resource utilization of an electronic device.

### BRIEF DESCRIPTION OF THE DRAWINGS

FIG. 1 is a schematic architectural diagram of an object interaction system according to an aspect described herein;

FIG. 2 is a schematic structural diagram of an electronic device according to an aspect described herein;

FIG. 3 is a schematic flowchart of an object interaction method according to an aspect described herein;

FIG. 4 is a schematic diagram of a second virtual object according to an aspect described herein;

FIG. 5 is a schematic diagram of displaying a note effect at an associated position of a second virtual object according to an aspect described herein;

FIG. 6 is a schematic diagram of an interaction operation identifier in an inactive state according to an aspect described herein;

FIG. 7 is a schematic diagram of an interaction operation identifier in an active state according to an aspect described herein;

FIG. 8 is a schematic diagram of difficulty prompt information according to an aspect described herein;

FIG. 9 is a schematic diagram of interaction failure prompt information according to an aspect described herein;

FIG. 10 is a schematic diagram of an interaction success identifier according to an aspect described herein;

FIG. 11 is a schematic diagram of an interaction failure identifier according to an aspect described herein;

FIG. 12 is a schematic flowchart of an audio puzzle solving method in a shooting game according to an aspect described herein;

FIG. 13 is a schematic diagram of a singing management setting according to an aspect described herein;

FIG. 14 is a schematic state diagram of a component according to an aspect described herein;

FIG. 15 is a schematic logic diagram of an interaction process according to an aspect described herein;

FIG. 16 is a flowchart of a preparation process of a monster singing process according to an aspect described herein;

FIG. 17 is a flowchart of a monster singing process according to an aspect described herein; and

FIG. 18 is a flowchart of determining an interaction result of a first virtual object based on an attack operation performed by the first virtual object according to an aspect described herein.

### DETAILED DESCRIPTION

To make the objectives, technical solutions, and advantages described herein clearer, the following describes aspects described herein in further detail with reference to the accompanying drawings. The described aspects are not to be considered as a limitation to the aspects described herein. All other aspects obtained by a person of ordinary skill in the art without creative efforts fall within the protection scope described herein.

In the following description, reference is made to “some aspects” which describe a subset of all possible aspects. However, “some aspects” may be the same subset or different subsets of all possible aspects and may be combined with each other without conflict.

The term “first/second/third” involved in the following descriptions is merely used for distinguishing between similar objects and does not denote a specific order of objects. Specific order or sequence of the term “first/second/third” may be interchanged where permitted such that the aspects of the disclosure described herein can be implemented in order other than that illustrated or described herein.

Unless otherwise defined, meanings of all technical and scientific terms used in this specification are the same as those usually understood by a person skilled in the art to which this application belongs. Terms used herein are merely intended to describe the aspects described herein, but are not intended to limit this application.

Before the aspects described herein are further described in detail, a description is made on nouns and terms in the aspects described herein, and the nouns and terms in the aspects described herein are applicable to the following explanations.
1) A shooting game is a game that uses hot weapons for long-range attack, including, but not limited to, a first-person shooting game and a third-person shooting game.
2) A third-person perspective is a perspective in which an in-game camera is located at a specific distance behind a player character, so that the character and all fight elements in a specific surrounding environment may be seen in a picture.
3) Response represents a condition or state upon which performed operations depend, where one or more of the performed operations may be real-time or may have a set delay when the dependent condition or state is satisfied. Without being specifically stated, there is no limitation to the order in which the operations are performed.
4) A virtual scene is a virtual scene displayed (or provided) when an application runs on a terminal. The virtual scene may be a simulated environment of a real world, or may be a semi-simulated and semi-fictional virtual environment, or may be a completely fictional virtual environment. The virtual scene may be any one of a two-dimensional virtual scene, a two-and-a-half-dimensional virtual scene, or a three-dimensional virtual scene.

For example, the virtual scene may include sky, land, ocean, and the like. The land may include environmental elements such as desert and city, and a user may control a virtual object to perform an activity in the virtual scene. The activity includes, but is not limited to at least one of adjusting body posture, crawling, walking, running, riding, jumping, driving, picking up, shooting, attacking, or throwing. The virtual scene may be displayed from a first-person perspective (for example, a user's own perspective is used to play a virtual object in a game), may alternatively be displayed from a third-person perspective (for example, a user chases a virtual object in a game to play the game), or may be a virtual scene displayed from an aerial perspective. The perspectives may be switched randomly.
5) A virtual object is a figure of various people and objects that may be interacted with in a virtual scene, or a movable object in the virtual scene. The movable objects may be a virtual character, a virtual animal, an animation character, and the like, for example, people, animals, plants, oil drums, walls, and stones displayed in the virtual scene. The virtual object may be a virtual image used for representing a user in the virtual scene. The virtual scene may include a plurality of virtual objects. Each virtual object has a shape and a volume in the virtual scene, and occupies some space in the virtual scene.

For example, the virtual object may be a user character controlled through operations on the client, may be artificial intelligence (AI) set in a virtual scene fight through training, or may be a non-player character (NPC) set in virtual scene interaction. A quantity of virtual objects participating in the interaction in the virtual scene may be preset or dynamically determined based on a quantity of interactive clients.
6) A client is a program corresponding to a server that provides a local service to a user. In addition to some applications that can only run locally, the client is generally installed on an ordinary user device and needs to cooperate with the server to run. In other words, the client requires a corresponding server and service program in a network to provide a corresponding service. In this way, a specific communication connection needs to be established between the client and a server side, to ensure a normal operation of an application. The client is, for example, a game client.
7) An open world refers to a virtual game scene in which battle scenes in a game are completely free and open. In the open world, a player may freely move forward and explore in any direction, and a very large distance is defined between boundaries in various directions.
8) A scale is a group of sound trains that sequentially arrange pitches according to a particular rule.
9) A user interface (UI) is a medium for interaction and information exchange between a system and a user, and is configured for implementing conversion between an internal form of information and a form that can be accepted by a human.

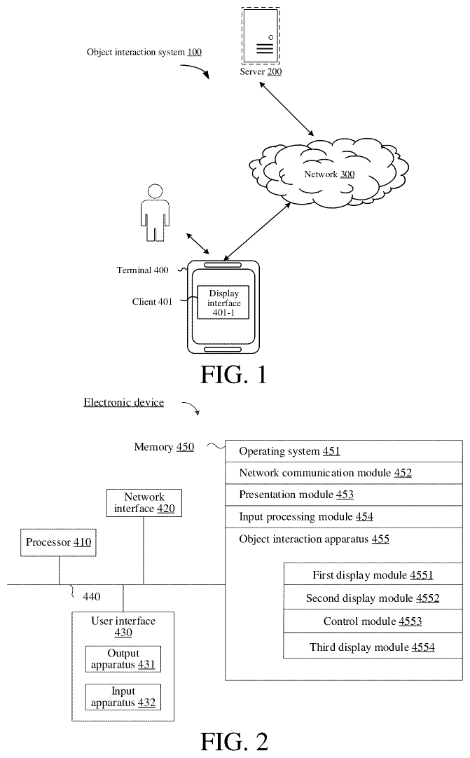

Refer to FIG. 1. FIG. 1 is a schematic architectural diagram of an object interaction system 100 according to an aspect described herein. A terminal (for example, a terminal 400 is shown) is connected to a server 200 via a network 300. The network 300 may be a wide area network, a local area network, or a combination thereof. The terminal 400 is configured for a user to perform display on a display interface (for example, a display interface 401-1 is shown) by using a client 401. The terminal 400 and the server 200 are connected to each other via a wired or wireless network.

The server 200 is configured to transmit a virtual scene including a first virtual object and M second virtual objects to the terminal 400.

The terminal 400 is further configured to: receive the virtual scene including the first virtual object and the M second virtual objects; present the virtual scene, and display the first virtual object and the M second virtual objects in the virtual scene, where M is a positive integer greater than 1, the second virtual object is configured for outputting at least one note, and at least some notes outputted by different second virtual objects are different; display a process in which N second virtual objects output target notes, where N is a positive integer and N is less than or equal to M; control, in response to an interaction operation on the M second virtual objects, the first virtual object to interact with the M second virtual objects; and display an interaction result of the first virtual object with reference to an output sequence of the target notes and an interaction sequence of the first virtual object with the M second virtual objects.

In some aspects, the server 200 may be an independent physical server, or may be a server cluster formed by a plurality of physical servers or a distributed system, and may further be a cloud server providing basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal 400 may be a smartphone, a tablet computer, a notebook computer, a desktop computer, a set-top box, an intelligent voice interactive device, a smart home appliance, a virtual reality device, an on-board terminal, an aircraft, a mobile device (for example, a mobile phone, a portable music player, a personal digital assistant, a dedicated messaging device, a portable game device, a smart speaker, and a smartwatch), or the like, but is not limited thereto. The terminal device may be connected directly or indirectly to the server in a wired or wireless communication mode. This is not limited described herein.

The following describes an electronic device that implements an object interaction method according to an aspect described herein. Refer to FIG. 2. FIG. 2 is a schematic structural diagram of an electronic device according to an aspect described herein. The electronic device may be a server or a terminal. An example in which the electronic device is the terminal shown in FIG. 1 is used. The electronic device shown in FIG. 2 includes: at least one processor 410, a memory 450, at least one network interface 420, and a user interface 430. Components in the terminal 400 are coupled by a bus system 440. The bus system 440 is configured to implement connection and communication between the components. In addition to a data bus, the bus system 440 further includes a power bus, a control bus, and a status signal bus. However, for clarity, various buses are marked as the bus system 440 in FIG. 2.

The processor 410 may be an integrated circuit chip having signal processing capabilities, for example, a general-purpose processor, a digital signal processor (DSP), or another programmable logic device, discrete gate or transistor logic device, or discrete hardware component. The general-purpose processor may be a microprocessor, any conventional processor, or the like.

The user interface 430 includes one or more output apparatuses 431 that can display media content, including one or more speakers and/or one or more visual display screens. The user interface 430 further includes one or more input apparatuses 432, including user interface components that facilitate user input, such as a keyboard, a mouse, a microphone, a touchscreen, a camera, and other input buttons and controls.

The memory 450 may be removable, irremovable or a combination thereof. The illustrative hardware device includes a solid-state memory, a hard disk drive, an optical disk drive, and the like. In some aspects, the memory 450 includes one or more storage devices physically located away from the processor 410.

The memory 450 includes a volatile memory or a non-volatile memory, or may include both a volatile memory and a non-volatile memory. The non-volatile memory may be a read only memory (ROM), and the volatile memory may be a random access memory (RAM). The memory 450 described in this aspect described herein aims to include any suitable type of memory.

In some aspects, the memory 450 can store data to support various operations. Examples of the data include a program, a module, a data structure, or a subset or a superset thereof, which are described below by way of example.

An operating system 451 includes system programs configured to process various basic system services and perform hardware-related tasks, for example, a framework layer, a core library layer, and a driver layer, which are configured to implement various basic services and process hardware-based tasks.

A network communication module 452 is configured to reach another electronic device via one or more (wired or wireless) network interfaces 420. For example, the network interface 420 includes: Bluetooth, wireless fidelity (WiFi), universal serial bus (USB), or the like.

A presentation module 453 is configured to enable display of information through the one or more output apparatuses 431 (for example, a display screen and a speaker) associated with the user interface 430 (for example, a user interface configured to operate a peripheral device and display content and information).

An input processing module 454 is configured to detect one or more user inputs or interactions from the input apparatuses 432 and translate the detected inputs or interactions.

In some aspects, an apparatus provided in this aspect described herein may be implemented by software. FIG. 2 shows an object interaction apparatus 455 stored in the memory 450, which may be software in the form of programs and plug-ins, including the following software modules: a first display module 4551, a second display module 4552, a control module 4553, and a third display module 4554. These modules are logical, so that the modules may be arbitrarily combined or further split according to implemented functions. The functions of the modules are to be explained below.

In some aspects, the apparatus provided in this aspect described herein may be implemented by hardware. As an example, the object interaction apparatus provided in this aspect described herein may be a processor in the form of a hardware decoding processor, programmed to perform the object interaction method provided in an aspect described herein. For example, the processor in the form of the hardware decoding processor may use one or more application specific integrated circuits (ASIC), a DSP, a programmable logic device (PLD), a complex programmable logic device (CPLD), a field-programmable gate array (FPGA), or other electronic components.

In some aspects, the terminal or the server may implement the object interaction method provided in an aspect described herein by running a computer program. For example, the computer program may be an original program or a software module in an operating system, may be a native application (APP), namely a program that needs to be installed in the operating system to run, such as an instant messaging APP, and a web browser APP, may alternatively be a mini program, which may be run after being simply downloaded to a browser environment, or may be a mini program that can be embedded in any APP. In summary, the foregoing computer program may be an application, a module, or a plug-in in any form.

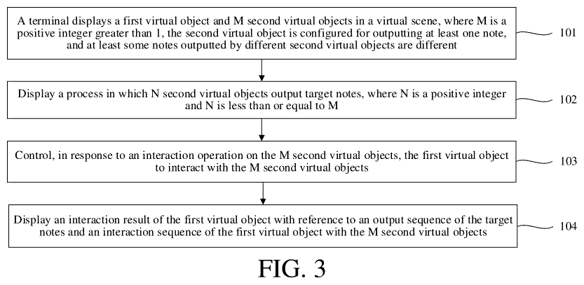

Based on the foregoing descriptions of the object interaction system and the electronic device provided in the aspects described herein, the following describes an object interaction method provided in an aspect described herein. In an actual implementation, the object interaction method provided in this aspect described herein may be implemented by a terminal or a server alone, or may be implemented by the terminal and the server collaboratively. A description is given by using an example in which the terminal 400 in FIG. 1 alone performs the object interaction method provided in this aspect described herein. FIG. 3 is a flowchart of an object interaction method according to an aspect described herein. The method is described with operations shown in FIG. 3.

Operation 101: A terminal displays a first virtual object and M second virtual objects in a virtual scene, where M is a positive integer greater than 1, the second virtual object is configured for outputting at least one note, and at least some notes outputted by different second virtual objects are different.

In actual implementation, an application that supports a virtual scene is installed on the terminal. The application may be any one of a first-person shooting game, a third-person shooting game, a multiplayer online battle arena game, a virtual reality application, a three-dimensional map program, or a multiplayer gunfight survival game. A user may operate a virtual object located in the virtual scene by using the terminal to perform activities.

When the user opens an application on the terminal and the terminal runs the application, the terminal presents a picture of a virtual scene. The picture of the virtual scene herein is obtained by observing the virtual scene from a first-person object perspective, or is obtained by observing the virtual scene from a third-person perspective. The picture of the virtual scene includes a first virtual object and a second virtual object. The first virtual object may be a player character controlled by a current player, or may be a player character controlled by another player (teammate) belonging to a same group as the current player. The second virtual object may be a player character controlled by another player in an enemy camp with the player character controlled by the current player, may be an AI-controlled object in the virtual scene for interaction by a player, an NPC in the virtual scene, or the like.

That a second virtual object outputs a note may mean that the second virtual object directly emits an audio of a corresponding note at singing, or may mean that the second virtual object plays an audio of a corresponding note by using a musical instrument such as a violin and a piano. Musical instruments corresponding to different second virtual objects may be the same or different. Meanwhile, at least one note herein indicates a scale, for example, a C major scale and an A minor scale. The scale includes a plurality of unit scales, for example, seven unit scales: do, re, mi, fa, so, la, and ti, or five unit scales: C, DEbE, G, A, and C in a C major Blues scale. One note may correspond to one unit scale. Herein, notes outputted by different second virtual objects are completely different. To be specific, each second virtual object may output only one note. Notes outputted by different second virtual objects are partially different. To be specific, each second virtual object may output a plurality of notes.

For example, when the quantity of second virtual objects is seven and each second virtual object outputs only one note, the seven second virtual objects respectively output different notes, namely, seven unit notes: do, re, mi, fa, so, la, and ti respectively. Alternatively, when the quantity of second virtual objects is five and each second virtual object outputs only one note, the five second virtual objects respectively output different notes, namely, five unit notes: C, DEbE, G, A, and C respectively. Alternatively, when the quantity of second virtual objects is five and each second virtual object outputs a plurality of notes, second virtual object 1 may output C and DEbE, second virtual object 2 may output DEbE and G, second virtual object 3 may output G and A, second virtual object 4 may output A and C, and second virtual object 5 may output C and C. Herein, the notes outputted by the plurality of second virtual objects, the quantity of notes, the notes outputted by each second virtual object, and the quantity of notes include, but are not limited to, the foregoing cases. This is not limited in this aspect described herein.

In some aspects, the first virtual object and the M second virtual objects are displayed in a first virtual space of the virtual scene. Before the first virtual object and the M second virtual objects are displayed in the first virtual space of the virtual scene, the first virtual object and a virtual scene element attributable to a natural phenomenon are displayed in a second virtual space of the virtual scene. The virtual scene element is converted into a transport entrance when a conversion condition of the virtual scene element is satisfied. The first virtual object is transported from the second virtual space to the first virtual space when the first virtual object is within a sensing region of the transport entrance.

The transport entrance may be presented in a form of a virtual portal, or may be presented in another form. This is not limited in this aspect described herein. The first virtual space and the second virtual space are both preset, and are attributable to a same virtual scene. The first virtual space and the second virtual space may be set to virtual spaces such as a desert, an ocean, a castle, or a jungle, and a virtual natural phenomenon to which the virtual scene element is attributable may be a natural phenomenon caused by an environment such as a tornado or a volcano.

In an actual application, the virtual scene element attributable to the natural phenomenon is displayed, and a transport condition of the first virtual object is defined. To be specific, the first virtual object is transported only when the first virtual object is located within the sensing region of the virtual scene element, thereby increasing diversity in an interaction process, improving immersion and interactive experience of a user, and improving human-computer interaction efficiency and hardware resource utilization of an electronic device.

In an actual implementation, when the first virtual object is located within the sensing region of the virtual scene element, the sensing region herein is a circular region using the virtual scene element as a center and a target distance as a radius. The target distance herein is preset, for example, 5 meters. The process of determining that the first virtual object is located within the sensing region of the virtual scene element specifically includes that: the terminal obtains a position of the first virtual object in the second virtual space, a position of the virtual scene element, and the sensing region of the virtual scene element, obtains a distance between the first virtual object and the virtual scene element based on the position of the first virtual object and the position of the virtual scene element, and compares the distance with the radius of the sensing region namely the target distance. When the comparison result indicates that the distance is less than the radius of the sensing region, it is determined that the first virtual object is located within a sensing range of the virtual scene element. When the comparison result indicates that the distance is greater than the target distance indicated by a sensing range of a virtual natural element, it is determined that the first virtual object is not within the sensing range of the virtual natural element.

When the first virtual object is located within the sensing region of the virtual scene element, the first virtual object may be directly transported from the second virtual space to the first virtual space. Alternatively, the first virtual object may be transported from the second virtual space to the first virtual space based on a duration for which the first virtual object is within the sensing region. Specifically, the process of transporting the first virtual object from the second virtual space to the first virtual space when the first virtual object is located within the sensing region of the virtual scene element may be: displaying a stay duration of the first virtual object within the sensing region when the first virtual object is located within the sensing region of the virtual scene element; and transporting the first virtual object from the second virtual space to the first virtual space when the stay duration reaches a stay duration threshold. For example, when the first virtual object is located within the sensing region of the virtual scene element, a stay duration of the first virtual object in the second virtual space is detected. The first virtual object is transported from the second virtual space to the first virtual space when the detection result indicates that the stay duration of the first virtual object in the second virtual space reaches a stay duration threshold, for example, 5 seconds. The stay duration threshold may alternatively be preset. This is not limited in this aspect described herein.

By applying the foregoing aspect, a transport condition of the first virtual object is further limited. For example, only when the stay duration of the first virtual object in the sensing region reaches the stay duration threshold, the first virtual object is transported from the first virtual space to the second virtual space. In this way, the diversity of an interaction process in a virtual scene and the enthusiasm of users to explore in the virtual scene are improved, thereby improving the human-computer interaction efficiency and the hardware resource utilization of the electronic device.

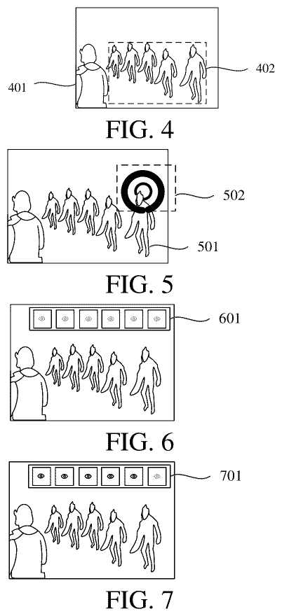

At least one second virtual object of the first virtual space may be virtual objects of different types, for example, may be at least one of a plant form, an animal form, a character form, or a monster form. The M second virtual objects may be standing in the virtual scene, or may be lying in the virtual scene, or some second virtual objects are standing in the virtual scene while some second virtual objects are lying in the virtual scene. The state and form of the second virtual objects in the virtual scene are not limited in this aspect described herein. For example, refer to FIG. 4. FIG. 4 is a schematic diagram of a second virtual object according to an aspect described herein. Based on FIG. 4, a first virtual object is indicated by 401, and five second virtual objects are indicated in a dashed box 402, where the form of the second virtual object is a character form, and the state is a standing state.

Operation 102: Display a process in which N second virtual objects output target notes, where N is a positive integer and N is less than or equal to M.

When the first virtual object initially appears in the virtual scene, the N second virtual objects do not immediately output the target notes. Instead, when the first virtual object appears in the virtual scene for a particular duration, the N second virtual objects immediately output the target notes. Specifically, a stay duration of the first virtual object in the virtual scene is displayed. The process in which the N second virtual objects output the target notes is displayed when the stay duration reaches a target stay duration.

In an actual implementation, when the first virtual object initially appears in the virtual scene, a moment at which the first virtual object initially appears in the virtual scene such as the first virtual space of the virtual scene is obtained, and a time interval between the moment at which the first virtual object initially appears and a current moment, namely the stay duration, is compared with the target stay duration in real time. When the comparison result indicates that the stay duration reaches the target stay duration, the N second virtual objects are controlled to output the target notes. For example, when the first virtual object initially appears in the virtual scene, the stay duration of the first virtual object in the virtual scene is detected. When the detection result indicates that the stay duration of the first virtual object in the virtual scene reaches the stay duration threshold, for example, 5 seconds, the N second virtual objects are controlled to output the target notes.

In an actual application, a condition under which the N second virtual objects output the target notes is further limited. For example, the N second virtual objects output the target notes only when the stay duration of the first virtual object in the virtual scene reaches the target stay duration. In this way, the diversity of an interaction process in the virtual scene is improved, thereby improving the human-computer interaction efficiency and the hardware resource utilization of the electronic device.

The process in which the N second virtual objects output the target notes is displayed as: controlling each second virtual object among the N second virtual objects to respectively output the corresponding note. Herein, all second virtual objects among the M second virtual objects output the target notes, or some second virtual objects among the M second virtual objects output the target notes. The quantity of second virtual objects outputting the target notes is not limited in this aspect described herein.

In some aspects, in the process in which the N second virtual objects output the target notes, a note effect is displayed at an associated position of the second virtual object. The note effect is configured for indicating that the second virtual object is outputting a target note, and matches the target note outputted by the second virtual object. Herein, the associated position is configured for indicating one of an upper position, a lower position, a left position, and a right position of the corresponding second virtual object. Associated positions of different second virtual objects may be different. Different notes may correspond to a same note effect, or may correspond to different note effects, and pitch levels of different notes may also correspond to different note effects. For example, when the quantity of second virtual objects is five, the quantity of target notes is also five. Therefore, for target notes emitted by different second virtual objects, note effects, such as a halo, corresponding to the target notes may be displayed above the second virtual objects. When the pitch level of the target notes emitted by the second virtual objects is positively correlated to the luminance or the quantity of halos corresponding to the target notes displayed above the second virtual objects. For example, refer to FIG. 5. FIG. 5 is a schematic diagram of displaying a note effect at an associated position of a second virtual object according to an aspect described herein. Based on FIG. 5, when a second virtual object indicated by 501 emits a target note, a note effect, namely a halo, corresponding to the note indicated by a dashed box 502 is displayed above the second virtual object. In this way, even if a user is a hearing impairment user, a second virtual object that currently emits a target note is prompted, by using the note effect, to the user, so that the user perceives a sequence in which at least one second virtual object emits the target note, thereby improving applicability of an interaction process and user experience.

In some aspects, after the first virtual object and the M second virtual objects are displayed in the virtual scene, at least one interaction operation identifier in an inactive state may further be displayed. A quantity of the interaction operation identifiers is configured for indicating a total quantity of target notes outputted by the N second virtual objects. The interaction operation identifiers and the target notes are in a one-to-one correspondence. The interaction operation identifier in the inactive state is configured for indicating that a corresponding target note is not outputted yet. Herein, the interaction operation identifier may be a pattern identifier in any form. The inactive state may indicate that the interaction operation identifier is in a gray state. The gray state is configured for indicating that a corresponding target note is not outputted by a corresponding second virtual object. For example, refer to FIG. 6. FIG. 6 is a schematic diagram of an interaction operation identifier in an inactive state according to an aspect described herein. Based on FIG. 6, six interaction operation identifiers in an inactive state are indicated by 601. The six interaction operation identifiers indicate that at least one second virtual object is to output six target notes, and no second virtual object has outputted a target note.

By applying the foregoing aspect, a user is prompted with a quantity of interaction operations to be performed by displaying an interaction operation identifier in an inactive state. In this way, the user is given the quantity of interaction operations to be performed, which not only improves diversity of an interaction process in a virtual scene, but also reduces a possibility that the user cancels an interaction operation in the halfway, thereby improving human-computer interaction efficiency and hardware resource utilization of an electronic device.

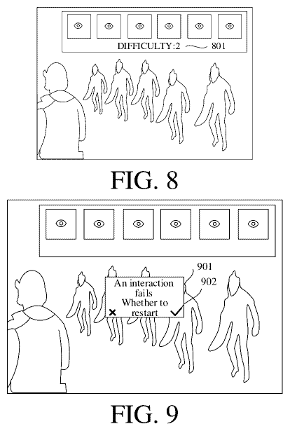

In some aspects, the state of the interaction operation identifier may further be switched with a process in which the second virtual objects output the target notes. Specifically, the interaction operation identifier corresponding to the currently outputted target note is switched from the inactive state to an active state in the process in which the N virtual objects output the target notes. When the interaction operation identifiers are all in an active state, the quantity of interaction operation identifiers in the active state is configured for indicating a quantity of interaction operations to be performed by the first virtual object with the M second virtual objects. Herein, the active state may indicate that the interaction operation identifier is in a bright state. The bright state is configured for indicating that a corresponding target note is outputted by a corresponding second virtual object. For example, refer to FIG. 7. FIG. 7 is a schematic diagram of an interaction operation identifier in an active state according to an aspect described herein. Based on FIG. 7, first five interaction operation identifiers in FIG. 7 are in an active state. To be specific, target notes corresponding to the first five interaction operation identifiers are outputted. A sixth interaction operation identifier is in an inactive state. To be specific, a target note corresponding to the sixth interaction operation identifier is not outputted.

In an actual application, by displaying the quantity of interaction operation identifiers in an active state, the user is prompted with the quantity of interaction operations to be further performed. In addition, by using a state switching process of the interaction operation identifier, the user is also prompted with whether interaction is correct. In this way, not only interaction difficulty is reduced, but also the diversity of the interaction process in the virtual scene is improved, and interaction enthusiasm of the user is improved.

As the second virtual object outputs the target note, the corresponding interaction operation identifier is switched from the inactive state to the active state. Only when all interaction operation identifiers are in the active state, to be specific, after at least one second virtual object outputs the target note, the first virtual object may perform the interaction operation on the second virtual object. To be specific, in a process in which the second virtual object outputs the target note, the interaction operation performed by the first virtual object on the second virtual object cannot be received.

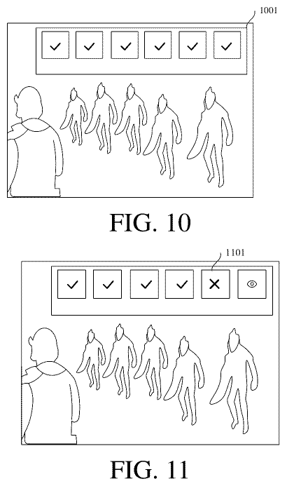

In some aspects, after the first virtual object and the M second virtual objects are displayed in the virtual scene, difficulty prompt information may further be displayed. The difficulty prompt information is configured for indicating a difficulty level at which the first virtual object performs the interaction operations. Herein, the displayed difficulty level information indicates a difficulty level of each interaction operation to be currently performed by the first virtual object. For example, refer to FIG. 8. FIG. 8 is a schematic diagram of difficulty prompt information according to an aspect described herein. Based on FIG. 8, the difficulty prompt information herein indicates that a difficulty level of each interaction operation performed by the first virtual object is a second level.

The difficulty level may be preset, or may be determined according to a current game attribute of the first virtual object, such as a game record, a win rate, or a game level. For example, a higher game level of the first virtual object indicates a higher current difficulty level. Therefore, after the first virtual object and the M second virtual objects are displayed in the virtual scene, a game attribute of the first virtual object is obtained, and a difficulty level at which the first virtual object performs each interaction operation is determined based on the game attribute. Therefore, the difficulty prompt information is displayed based on the difficulty level. Herein, difficulty levels of interaction operations performed by first virtual objects controlled by different users may be different. A manner of determining the difficulty level of each interaction operation performed by the first virtual object is not limited in this aspect described herein.

By applying the foregoing aspect, a user is prompted with an interaction difficulty of an interaction process in advance by displaying difficulty prompt information, which not only improves diversity of an interaction process in a virtual scene, but also reduces a possibility that the user cancels an interaction operation in the halfway, thereby improving human-computer interaction efficiency and hardware resource utilization of an electronic device.

Operation 103: Control, in response to an interaction operation on the M second virtual objects, the first virtual object to interact with the M second virtual objects.

The second virtual objects interacting with the first virtual object may be all second virtual objects outputting the target notes, or may be some second virtual objects outputting the target notes. To be specific, the quantity of the second virtual objects outputting the target notes is a first quantity, the quantity of the second virtual objects interacting with the first virtual object is a second quantity, and the second quantity is not greater than the first quantity.

In an actual implementation, after a process in which the N second virtual objects output the target notes is displayed, an interaction operation on the M second virtual objects is received. The interaction operation herein may be an attack operation on the M second virtual objects, or may be a scanning operation on the N second virtual objects. A form of the interaction operation is not limited in this aspect described herein.

In some aspects, in a process in which the first virtual object performs the interaction operation on the M second virtual objects, a process in which the interacted second virtual objects output corresponding target notes is displayed. Herein, in the process in which the first virtual object interacts with the M second virtual objects, the process in which the interacted second virtual objects output the corresponding target notes is displayed. To be specific, each time the first virtual object performs the interaction operation with the corresponding second virtual object, the corresponding second virtual object outputs a note corresponding to the first virtual object.

In this way, each time the first virtual object performs an interaction operation on a corresponding second virtual object, the corresponding second virtual object outputs corresponding notes, so that a process in which the first virtual object performs the interaction operation is also equivalent to a playing process of the first virtual object, thereby improving diversity and interest in an object interaction process.

In some aspects, in the process in which the first virtual object interacts with the M second virtual objects, interaction effects may further be displayed in response to the interaction operations performed by the first virtual object. The interaction effects and the interaction operations are in a one-to-one correspondence. Herein, each interaction effect may correspond to the note effect described above. The interaction effect may be displayed at one of an upper position, a lower position, a left position, or a right position of the corresponding second virtual object, or may be displayed at one of an upper position, a lower position, a left position, or a right position of the first virtual object. Different interaction operations may correspond to different or same interaction effects. Alternatively, interaction operations performed on a same second virtual object may correspond to same interaction effects, or interaction operations performed on different second virtual objects may correspond to different interaction effects. This is not limited in this aspect described herein.

By applying the foregoing aspect, each time a first virtual object performs an interaction operation on a corresponding second virtual object, an interaction characteristic is further correspondingly displayed. In this way, diversity and interestingness in an object interaction process are improved, interaction enthusiasm of a user is enhanced, and human-computer interaction efficiency and hardware resource utilization of an electronic device are further improved.

In some aspects, the first virtual object further has a calling object. The calling object is configured for assisting the first virtual object in interacting with the second virtual objects, so that the process of controlling the first virtual object to interact with the M second virtual objects may be controlling the calling object to cooperate with the first virtual object to interact with the M second virtual objects.

The calling object may be a figure of various people and things that may help the first virtual object interact with the second virtual object in the virtual scene. The figure may be a virtual character, a virtual animal, an animation character, or the like. For example, the calling object may be an object controlled by artificial intelligence in the virtual scene, or a non-user character in the virtual scene. A manner in which the calling object coordinates the first virtual object to interact with the second virtual objects may be attacking the corresponding second virtual objects. The calling object may be following the first virtual object momently, or may be called by the first virtual object before interacting with the second virtual objects. The calling object may be called by the first virtual object using a target skill or a target prop. This is not limited in this aspect described herein.

In an actual application, the calling object cooperates with the first virtual object to interact, thereby enriching an interaction process, increasing diversity and interest in the object interaction process, and strengthening interaction enthusiasm of a user. In addition, interaction difficulty in the object interaction process is reduced, and interaction enthusiasm of the user is further strengthened, thereby improving the human-computer interaction efficiency and the hardware resource utilization of the electronic device.

In some aspects, the N second virtual objects include at least one object combination. The object combination includes a second virtual object corresponding to a first note and a second virtual object corresponding to a second note. The first note and the second note form a combined note. When the combined note exists, two different second virtual objects, namely the second virtual object outputting the first note and the second virtual object outputting the second note, may be separately attacked by using the first virtual object and the calling object at the same time. Therefore, the process of controlling the calling object to cooperate with the first virtual object to interact with the M second virtual objects may be: controlling, for each object combination, the first virtual object to perform an interaction operation on the second virtual object corresponding to the first note, and controlling the calling object to perform an interaction operation on the second virtual object corresponding to the second note.

The first note and the second note are both outputted target notes. An output time interval between the first note and the second note may be less than a target time interval. Herein, the target time interval may be preset, for example, 0.5 seconds.

By applying the foregoing aspect, a first virtual object and a calling object simultaneously interact with different second virtual objects based on a combined note. In this way, not only an interaction process is enriched, diversity and interest in an object interaction process are improved, but also interaction difficulty in the object interaction process is increased, and interaction enthusiasm of a user is further strengthened.

In some aspects, the process of separately attacking two different second virtual objects by using the first virtual object and the calling object may be: when the first virtual object interacts with the second virtual object corresponding to the second note, controlling the calling object to lock the second virtual object corresponding to the second note, so that when the first virtual object interacts with the second virtual object corresponding to the first note, the calling object performs the interaction operation on the second virtual object corresponding to the second note. Specifically, for the process of controlling the calling object to lock the second virtual object corresponding to the second note when the first virtual object interacts with the second virtual object corresponding to the second note, the interaction operation performed by the first virtual object may be the foregoing interaction operation, or may be an interaction operation different from the foregoing interaction operation. For example, when the foregoing interaction operation is a shooting operation, the interaction operation herein may be scanning, aiming, or the like. Next, using an example in which the first virtual object is aimed at the second virtual object corresponding to the second note, the calling object is controlled to lock the second virtual object corresponding to the second note. The process in which the calling object is controlled to cooperate with the first virtual object to interact with the second virtual objects is described.

In an actual implementation, before the first virtual object is controlled to perform the interaction operation on the second virtual object corresponding to the first note, the first virtual object may further be controlled to aim at the second virtual object corresponding to the second note by using a shooting prop in response to an aiming instruction for the first virtual object. In the process in which the first virtual object aims at the second virtual object corresponding to the second note by using the shooting prop, the calling object is controlled to lock the second virtual object corresponding to the second note. Therefore, the process of controlling the first virtual object to perform an interaction operation on the second virtual object corresponding to the first note, and controlling the calling object to perform an interaction operation on the second virtual object corresponding to the second note may be: controlling, for the second virtual object corresponding to the first note, the first virtual object to perform the interaction operation by using the shooting prop; and controlling the calling object to perform, by using a target skill or a target prop, an interaction operation on the locked second virtual object corresponding to the first note.

The process of controlling the calling object to lock the second virtual object corresponding to the second note may be based on a locking instruction. Specifically, a locking control for locking the second virtual object corresponding to the second note is displayed in the process in which the first virtual object aims at the second virtual object corresponding to the second note by using the shooting prop. In response to a locking instruction triggered based on the locking control, the calling object is controlled to lock the second virtual object corresponding to the second note. The second virtual object may alternatively be automatically locked. Specifically, an aiming duration is displayed in the process in which the first virtual object aims at the second virtual object corresponding to the second note by using the shooting prop. When the aiming duration reaches a target aiming duration, the calling object is controlled to lock the second virtual object corresponding to the second note. The manner of controlling the calling object to lock the second virtual object corresponding to the second note is not limited in this aspect described herein.

In an actual application, when the first virtual object is controlled to perform the interaction operation based on the shooting prop, the calling object is further controlled to use the target skill or the target prop to perform the interaction operation, thereby enriching an object interaction process, and improving diversity and interest in the object interaction process, thereby improving the human-computer interaction efficiency and the hardware resource utilization of the electronic device.

Operation 104: Display an interaction result of the first virtual object with reference to an output sequence of the target notes and an interaction sequence of the first virtual object with the M second virtual objects.

The interaction result of the first virtual object may be a result for indicating that the corresponding interaction operation of the first virtual object succeeds, or may be a result for indicating that the corresponding interaction operation fails.

In some aspects, the process of displaying an interaction result of the first virtual object with reference to an output sequence of the target notes and an interaction sequence of the first virtual object with the M second virtual objects may be: matching an execution sequence of the interaction operations performed by the first virtual object with a standard execution sequence, to obtain a matching result. The standard execution sequence corresponds to the output sequence of the target notes. Therefore, the interaction result of the first virtual object is displayed based on the matching result.

The standard execution sequence herein is determined based on the output sequence of the target notes. For example, the output sequence of the target notes is obtained. Then, an execution sequence of the interaction operations performed by the first virtual object on the second interaction objects is determined based on an output sequence of the second virtual objects outputting the target notes. In addition, in the matching process herein, for each interaction operation performed by the first virtual object, the second virtual objects on which the interaction operations are performed match the second virtual objects corresponding to the current interaction operation indicated in the standard execution sequence. Therefore, there are a plurality of matching results herein, and the matching results are in a one-to-one correspondence with the interaction operations.

In some aspects, interaction success indication information is displayed when the matching result indicates that the execution sequence matches the standard execution sequence, where the interaction success indication information is configured for indicating that the interaction result of the interaction operations performed by the first virtual object is successful. Herein, the matching result indicates that when the execution sequence matches the standard execution sequence, the interaction success indication information is configured for indicating that all interaction operations performed by the first virtual object interact successfully. To be specific, all matching results indicate that the second virtual objects on which the corresponding interaction operations are performed match the second virtual objects corresponding to the current interaction operation indicated in the standard execution sequence.

By applying the foregoing aspect, when a matching result indicates that an execution sequence matches a standard execution sequence, interaction success indication information is displayed, so as to prompt, based on interaction success prompt information, a user that the interaction succeeds. In this way, diversity of an interaction process in a virtual scene is improved, and game experience of the user is improved.

The interaction success indication information herein may be specific text information, for example, “Congratulations, interaction succeeds”, or may be presented by using a virtual resource. In addition, as described above, the first virtual object and the M second virtual objects are displayed in the first virtual space of the virtual scene. The first virtual object is transported from the second virtual space of the virtual scene to the first virtual space. Therefore, the interaction success indication information may be presented by using a transport entrance,

In some aspects, when the interaction success indication information is presented by using the virtual resource, specifically, a virtual resource used as a reward is displayed when the matching result indicates that the execution sequence matches the standard execution sequence, to be specific, when the interaction result indicates that the interaction sequence of the first virtual object on the second virtual objects matches the standard execution sequence. The standard execution sequence herein is also described above, and corresponds to the output sequence of the target notes. In addition, the virtual resource herein may be an interaction prop used in the virtual scene such as the first virtual space and/or the second virtual space described above and for the first virtual object, or may be an empirical value for increasing a level of the first virtual object.

By applying the foregoing aspect, after the user interacts successfully, the virtual resource is displayed, so that the user collects the virtual resource. In this way, diversity of the interaction process in the virtual scene is increased, and interaction experience of the user is improved, thereby improving human-computer interaction efficiency and hardware resource utilization of an electronic device.

In some aspects, when the interaction success indication information is presented by using the transport entrance, specifically, the transport entrance may be displayed when the matching result indicates that the execution sequence matches the standard execution sequence, to be specific, when the interaction result indicates that the interaction sequence of the first virtual object on the second virtual objects matches the standard execution sequence. In response to an entry instruction for the first virtual object, the first virtual object is controlled to enter the transport entrance, and the first virtual object is transported back to the second virtual space. Herein, the transport entrance may be displayed in a form of a virtual portal.

In an actual application, after the user interacts successfully, the transport entrance is displayed, so that the user transports back to the second virtual space. In this way, diversity of the interaction process in the virtual scene is increased, and interaction experience of the user is improved, thereby improving human-computer interaction efficiency and hardware resource utilization of an electronic device.

When the interaction success indication information may be specific text information, the virtual resource used as a reward and/or the transport entrance may also be displayed. Alternatively, the virtual resource used as a reward is displayed first, and the first virtual object is controlled to collect the virtual resource in response to a domain operation on the virtual resource. Then, after the first virtual object completes collecting the virtual resource, the transport entrance and the like are displayed. Alternatively, when the interaction success indication information is presented by using the virtual resource, the transport entrance may be displayed. Alternatively, the virtual resource used as a reward is displayed first, and the first virtual object is controlled to collect the virtual resource in response to a domain operation on the virtual resource. Then, after the first virtual object completes collecting the virtual resource, the transport entrance and the like are displayed. Alternatively, when the interaction success indication information is presented by using the transport entrance, the virtual resource may also be displayed. This is not limited in this aspect described herein.

In some other aspects, when the matching result indicates that the execution sequence does not match the standard execution sequence, to be specific, when a second virtual object on which the first virtual object performs a current interaction operation does not match a second virtual object on which a current interaction operation indicated by the standard execution sequence is performed, interaction failure prompt information is displayed.

The interaction failure prompt information is configured for indicating that the current interaction operation fails. The interaction failure prompt information may be specific text information, for example, “An interaction fails”, or may be presented by using a graphic identifier. For example, refer to FIG. 9. FIG. 9 is a schematic diagram of interaction failure prompt information according to an aspect described herein. Based on FIG. 9, when the second virtual object on which the first virtual object performs the current interaction operation does not match the second virtual object on which the current interaction operation indicated by the standard execution sequence is performed, interaction failure prompt information as indicated by 901 is displayed.

In an actual implementation, the interaction failure prompt information may be further configured for indicating whether to re-control the first virtual object to perform the interaction operation. Specifically, after the interaction failure prompt information is displayed, a process in which at least two second virtual objects output target notes is redisplayed when a confirmation instruction triggered based on the interaction failure prompt information is received. For example, still as shown in FIG. 9, after the interaction failure prompt information is displayed, when the confirmation instruction triggered based on the interaction failure prompt information is received, to be specific, when the confirmation instruction triggered based on a trigger operation of a confirmation control indicated by 902 in the interaction failure prompt information is received, the process in which at least two second virtual objects output target notes is redisplayed.

Herein, when the process in which at least two second virtual objects output target notes is redisplayed, the quantity of second virtual objects that re-output the target notes is not greater than M.

By applying the foregoing aspect, when user interaction fails, the process in which at least two second virtual objects output target notes is further redisplayed, so that the user performs interaction again. In this way, the first virtual object may perform interaction processes in the virtual scene for multiple times, diversity of the interaction processes in the virtual scene is increased, and interaction experience of the user is improved, thereby improving human-computer interaction efficiency and hardware resource utilization of the electronic device.

Herein, redisplaying the process in which at least two second virtual objects output target notes may be completely the same as displaying the process in which N second virtual objects output target notes before the first virtual object performs the interaction operation. To be specific, the process in which N second virtual objects output target notes is repeatedly displayed, so that the second virtual objects output the same target notes based on the same output sequence again. Alternatively, the process may be different from the process in which N second virtual objects output target notes, displayed before the first virtual object performs the interaction operation. Herein, the different process is described below.

In some aspects, the interaction failure prompt information may be displayed when the second virtual object on which the first virtual object performs the current interaction operation does not match the second virtual object on which the current interaction operation indicated by the standard execution sequence is performed, and the interaction failure prompt information may also be displayed in another manner. Specifically, an interaction waiting duration of the first virtual object is displayed in a process in which the first virtual object interacts. The interaction waiting duration is configured for indicating a time interval between a moment at which the first virtual object completes a previous interaction operation and a moment at which the first virtual object starts to perform a next interaction operation. Interaction failure prompt information is displayed when the interaction waiting duration reaches a target interaction waiting duration. The interaction failure prompt information is configured for indicating that the interaction result of the corresponding interaction operation is failure.

The target interaction waiting duration may be preset, for example, 5 seconds. When the first virtual object does not perform the interaction operation on the second virtual object within 5 seconds, interaction failure prompt information is displayed. The interaction failure prompt information is configured for indicating that an interaction result of an interaction operation to be performed by the first virtual object is failure.

In an actual application, the interaction failure prompt information is defined to be displayed when the interaction sequence is inconsistent with the standard execution sequence and when a time interval between two adjacent interaction operations reaches the target interaction waiting duration, thereby increasing diversity of the interaction process in the virtual scene, and improving enthusiasm of a user moving in the virtual scene.

In some aspects, for any interaction operation in a process in which the first virtual object interacts, an interaction success identifier corresponding to the interaction operation is displayed when an interaction result of the interaction operation is success. The interaction success identifier is configured for indicating that the interaction result of the corresponding interaction operation is success.

The process of determining that the interaction result of the interaction operation is success specifically includes: for a currently performed interaction operation, the execution sequence of the interaction operations performed by the first virtual object to a current moment is matched with the standard execution sequence when the interaction operation is completed, and it is determined that an interaction result of the currently performed interaction operation is success when the execution sequence of the interaction operations performed by the first virtual object is correct.

For each interaction operation, whether an interaction result of the corresponding interaction operation is successful is determined. The interaction success indication information described above is displayed only when the interaction results of all the interaction operations are success.

In an actual implementation, in a case that the interaction success identifier corresponding to the interaction operation is displayed when the interaction result of the interaction operation is success, a display position of the interaction success identifier herein may be an associated position of the interaction operation identifier. The associated position herein may be at least one of an upper position, a lower position, a left position, or a right position of the interaction operation identifier. The interaction operation identifier corresponding to the corresponding interaction operation may be switched to the interaction success identifier. A display process of the interaction success identifier is not limited in this aspect described herein.

For example, refer to FIG. 10. FIG. 10 is a schematic diagram of an interaction success identifier according to an aspect described herein. Based on FIG. 10, there are six interaction operations herein. When interaction results of the six interaction operations are success, interaction operation identifiers corresponding to the corresponding interaction operations are switched to interaction success identifiers, so that six interaction success identifiers as indicated by 1001 in FIG. 10 are displayed.

By applying the foregoing aspects, for any interaction operation, an interaction success identifier is displayed when an interaction sequence is correct. In this way, a user is promoted with the interaction success identifier that a sequence of the corresponding interaction operations is accurate. In this way, not only interaction enthusiasm of the user is improved, but also interaction difficulty in an object interaction process is reduced, and interaction enthusiasm of the user is further enhanced, thereby improving human-computer interaction efficiency and hardware resource utilization of an electronic device.

In some aspects, for any interaction operation in a process in which the first virtual object performs an interaction operation, an interaction failure identifier corresponding to the interaction operation is displayed when an interaction result of the interaction operation is failure. The interaction failure identifier is configured for indicating that the interaction result of the corresponding interaction operation is failure.

The process of determining that the interaction result of the interaction operation is failure specifically includes: for a currently performed interaction operation, the execution sequence of the interaction operations performed by the first virtual object to a current moment is matched with the standard execution sequence when the interaction operation is completed, and it is determined that an interaction result of the currently performed interaction operation is failure when the execution sequence of the interaction operations performed by the first virtual object is wrong.

Even if the interaction result of the previous interaction operation is success, when it is determined for the first time that the interaction result of the interaction operation is failure, or when the interaction results of a target quantity of interaction operations are failure, the interaction failure prompt information is displayed. Herein, the interaction failure identifier is equivalent to the interaction failure prompt information. For example, when it is determined for the first time that the interaction result of the interaction operation is failure, the interaction failure prompt information is displayed, and the interaction failure prompt information is a graphic identifier. The interaction failure identifier herein is the interaction failure prompt information, or may be different from the interaction failure prompt information. For example, the interaction failure identifier is displayed first, and then the interaction failure prompt information is displayed. This is not limited in this aspect described herein.

In an actual implementation, in a case that the interaction failure identifier corresponding to the interaction operation is displayed when the interaction result of the interaction operation is failure, a display position of the interaction failure identifier herein may be an associated position of the interaction operation identifier. The associated position herein may be at least one of an upper position, a lower position, a left position, or a right position of the interaction operation identifier. The interaction operation identifier corresponding to the corresponding interaction operation may be switched to the interaction failure identifier. A display process of the interaction failure identifier is not limited in this aspect described herein.

For example, refer to FIG. 11. FIG. 11 is a schematic diagram of an interaction failure identifier according to an aspect described herein. Based on FIG. 11, there are six interaction operations herein. When interaction results of the current three interaction operations are success, interaction operation identifiers corresponding to the corresponding interaction operations are switched to interaction success identifiers. For the fourth currently performed interaction operation, the execution sequence of the interaction operations performed by the first virtual object to a current moment is matched with the standard execution sequence when the interaction operation is completed, and it is determined that an interaction result of the fourth currently performed interaction operation is failure when the execution sequence of the interaction operations performed by the first virtual object is wrong. Therefore, the fourth corresponding interaction operation identifier is switched to the interaction failure identifier. To be specific, the interaction failure identifier shown in 1101 in FIG. 11 is displayed, and then the interaction failure prompt information is displayed.

In some aspects, the first virtual object may further correspond to a target quantity of interaction rounds. Each interaction round includes interaction operations on at least two second virtual objects. Different interaction rounds correspond to different difficulty levels. A quantity of the at least two second virtual objects in the interaction operations on the at least two second virtual objects included in each interaction round is not greater than M. Therefore, the redisplaying the process in which at least two second virtual objects output target notes is different from the displaying the process in which N second virtual objects output target notes before the first virtual object performs the interaction operation. To be specific, difficulty levels corresponding to respective interaction rounds of two target note output processes are different. Herein, based on a different interaction result of the first virtual object, difficulty levels corresponding to interaction rounds of the target note re-output process are also different.

When difficulty levels corresponding to interaction rounds of two target note output processes are the same, the redisplaying the process in which at least two second virtual objects output target notes may be the same as or different from the displaying the process in which N second virtual objects output target notes before the first virtual object performs the interaction operation. This is not limited in this aspect described herein.

In some aspects, when the interaction result of the first virtual object is a result indicating that the target quantity of interaction operations performed by the first virtual object interact successfully, the target operation herein may be preset, for example, may be half of the interaction operations in the interaction round, or all of the interaction operations in the interaction round. After the interaction result of the first virtual object is displayed with reference to the output sequence of the target notes and the interaction sequence of the first virtual object with the M second virtual objects, a difficulty level corresponding to a current interaction round may further be obtained. Therefore, when the interaction result indicates that an interaction in the current interaction round is successful and the difficulty level corresponding to the current interaction round is less than a highest difficulty level, a process in which K second virtual objects output target notes, so that the first virtual object performs an interaction operation included in a next interaction round. K is a positive integer and K is less than or equal to M. A difficulty level corresponding to the next interaction round is greater than the difficulty level corresponding to the current interaction round.

The difficulty level corresponding to the first interaction round of the first virtual object may be preset, or may be determined according to a current game attribute of the first virtual object, such as a game record, a win rate, or a game level. For example, a higher game level of the first virtual object indicates a higher difficulty level corresponding to the first interaction round. Herein, the target quantity may be preset, for example, 6. For example, when the target quantity is 6, a difficulty level corresponding to a current interaction round is 2, and a highest difficulty level is 6. In this case, when the interaction result indicates that an interaction in the current interaction round is successful and the difficulty level corresponding to the current interaction round is less than the highest difficulty level, a process in which K second virtual objects output target notes is redisplayed, so that the first virtual object performs an interaction operation included in a next interaction round. A difficulty level corresponding to the next interaction round may be one of 4, 5, and 6.

In an actual application, when the interaction result indicates that the interaction in the current interaction round is successful and the difficulty level corresponding to the current interaction round is less than the highest difficulty level, the process in which K second virtual objects output target notes is redisplayed, so that the first virtual object performs the interaction process again, thereby not only increasing diversity of the interaction process in the virtual scene and improving interaction experience of the user, but also improving resource utilization in the virtual scene.

In an actual implementation, the highest difficulty level may alternatively be preset. Different first virtual objects may correspond to different highest difficulty levels. Specifically, a plurality of different candidate difficulty levels are displayed, where different candidate difficulty levels correspond to different virtual resources. In response to a selection operation on a target candidate difficulty level among the plurality of candidate difficulty levels, the selected target candidate difficulty level is set to the highest difficulty level. When the interaction result indicates that an interaction in a current interaction round is successful and a difficulty level corresponding to the current interaction round is equal to the highest difficulty level, a virtual resource that corresponds to the highest difficulty level and is used as a reward is displayed.

By applying the foregoing aspect, a highest difficulty level may be defined to be voluntarily set by a user, to give the user sufficient autonomy, thereby not only improving diversity of an interaction process in a virtual scene and interaction enthusiasm of the user, but also improving user experience.

The virtual resource herein may be an interaction prop used in the virtual scene such as the first virtual space and/or the second virtual space described above and for the first virtual object, or may be an empirical value for increasing a level of the first virtual object. A higher difficulty level indicated by the target candidate difficulty level corresponds to richer corresponding virtual resources. When the interaction result indicates that the interaction in the current interaction round is successful, the difficulty level corresponding to the current interaction round is compared with the highest difficulty level. When the comparison result indicates that the difficulty level corresponding to the current interaction round is less than the highest difficulty level, the process in which K second virtual objects output target notes is redisplayed, so that the first virtual object performs an interaction operation included in a next interaction round until the difficulty level corresponding to the next interaction round is equal to the highest difficulty level. When the comparison result indicates that the difficulty level corresponding to the current interaction round is equal to the highest difficulty level, it is determined that the first virtual object interacts successfully. To be specific, the interaction success indication information described above, such as the virtual resource, may be displayed.

In some other aspects, when the interaction result of the first virtual object is a result indicating that the target quantity of interaction operations performed by the first virtual object interact unsuccessfully, the target operation herein may be preset, for example, may be half of the interaction operations in the interaction round, or one interaction operation in the interaction round. After the interaction result of the first virtual object is displayed with reference to an output sequence of the target notes and an interaction sequence of the first virtual object with the M second virtual objects, a difficulty level corresponding to a current interaction round may further be obtained when the interaction result indicates that an interaction in the current interaction round fails. When the difficulty level is greater than a lowest difficulty level, a process in which P second virtual objects output target notes is redisplayed, so that the first virtual object performs an interaction operation included in a next interaction round. P is a positive integer, P is less than or equal to M, and a difficulty level corresponding to the next interaction round is less than the difficulty level corresponding to the current interaction round.

The target quantity may be preset, for example, 6. For example, when the target quantity is 6, the difficulty level corresponding to the current interaction round is 3, and a lowest difficulty level is 2. In this case, the interaction result indicates that an interaction in the current interaction round fails and the difficulty level corresponding to the current interaction round is greater than the lowest difficulty level, a process in which P second virtual objects output target notes is redisplayed, so that the first virtual object performs an interaction operation included in a next interaction round. A difficulty level corresponding to the next interaction round may be 2.

In an actual application, when the interaction result indicates that the interaction in the current interaction round fails and the difficulty level corresponding to the current interaction round is greater than the lowest difficulty level, the process in which P second virtual objects output target notes is redisplayed, so that the first virtual object performs an interaction operation included in the next interaction round. In this way, not only diversity of the interaction process in the virtual scene is increased and interaction experience of the user is improved, but also human-computer interaction efficiency and hardware resource utilization of the electronic device are improved.

In an actual implementation, when the interaction result indicates that the interaction in the current interaction round fails, the difficulty level corresponding to the current interaction round is compared with the lowest difficulty level. When the comparison result indicates that the difficulty level corresponding to the current interaction round is greater than the lowest difficulty level, the process in which P second virtual objects output target notes is redisplayed, so that the first virtual object performs an interaction operation included in a next interaction round. When the comparison result indicates that the difficulty level corresponding to the current interaction round is equal to the lowest difficulty level, the process in which at least two second virtual objects output target notes is redisplayed, so that the first virtual object re-performs the interaction operation included in the current interaction round.

The note output process corresponding to the current interaction round is that the N second virtual objects output the target notes. Therefore, when the comparison result indicates that the difficulty level corresponding to the current interaction round is equal to the lowest difficulty level, the process in which at least two second virtual objects output target notes is redisplayed. The quantity of the at least two virtual objects re-outputting the target notes may be the same as N, or may be different from N. Similarly, redisplaying the process in which at least two second virtual objects output target notes may be the same as displaying the process in which N second virtual objects output target notes before the first virtual object performs the interaction operation, or may be different from displaying the process in which N second virtual objects output target notes before the first virtual object performs the interaction operation, provided that an interaction difficulty of a current round is the same as an interaction difficulty of an interaction round to be performed again by the first virtual object. This is not limited in this aspect described herein.

The quantity of interaction operations included in an interaction round having a high difficulty level is greater than the quantity of interaction operations included in an interaction round having a low difficulty level, and the quantity of second virtual objects outputting target notes in the interaction round having the high difficulty level may also be greater than the quantity of second virtual objects outputting target notes in the interaction round having the low difficulty level. This is not limited in this aspect described herein.

In some aspects, for a process in which at least two (for example, N, P, or K) second virtual objects output target notes, based on a difficulty level of a current interaction round, a target track corresponding to the difficulty level is first obtained. Then, a second virtual object outputting the target note and an output sequence in which the second virtual objects output the target notes are determined based on the target track and a note corresponding to each second virtual object, so that the at least two second virtual objects are controlled to output the target notes based on the output sequence.

The interaction operation performed by the first virtual object on the second virtual objects includes an effective interaction operation and an ineffective interaction operation. Only when the interaction operation is an effective interaction operation, an interaction result of the first virtual object is displayed with reference to the output sequence of the target notes and the interaction sequence of the first virtual object on the M second virtual objects. Herein, the effective interaction operation may be an interaction operation in which damage caused to the second virtual object is not less than a target damage, for example, an interaction operation triggered by executing a target skill, or an interaction operation triggered by executing a target prop. The ineffective interaction operation includes an interaction operation in which damage caused to the second virtual object is less than the target damage. After an interaction operation performed by the first virtual object on the second virtual object is received, the interaction operation is detected. When a detection result indicates that damage caused by the interaction operation on the second virtual object is not less than the target damage, the interaction operation is determined as an effective interaction operation. Herein, after the effective interaction operation performed by the first virtual object on the second virtual object is received, a life value of the second virtual object further needs to be controlled to be restored to a maximum life value, so that when the second virtual object receives a plurality of effective attacks, the second virtual object does not die.

In some aspects, when two interaction operations are performed on a same second virtual object, the two interaction operations are spaced by a target completion duration. Herein, the effective interaction operation and the ineffective interaction operation are also related to the target completion duration. Specifically, a completion duration of the interaction operation performed by the first virtual object on the second virtual object is displayed since the interaction operation performed by the first virtual object on the second virtual object is completed. When the completion duration is less than the target completion duration, the interaction operation indicated by the first virtual object may also be considered as an ineffective interaction operation. When the completion duration is not less than the target completion duration, the interaction operation indicated by the first virtual object may also be considered as an effective interaction operation. Therefore, in response to the interaction operation on the same second virtual object, when the completion duration is less than the target completion duration, to be specific, when the interaction operation is an ineffective interaction operation, waiting prompt information is displayed. The waiting prompt information is configured for prompting that when the completion duration reaches the target completion duration, interaction with the same second virtual object can be performed.

The waiting prompt information may be countdown information corresponding to the target completion duration. After completing performing the interaction operation on the second virtual object, if the first virtual object is intended to perform the interaction operation on the same second virtual object again, the first virtual object needs to wait for the target completion duration, namely a cooling duration. When the completion duration is less than the target completion duration, the waiting prompt information is displayed. When the completion duration is not less than the target completion duration, to be specific, when the interaction operation is an effective interaction operation, the first virtual object can perform the interaction operation again on the same second virtual object.

By applying the foregoing aspects described herein, after a first virtual object and M second virtual objects are displayed in a virtual scene, N second virtual objects are controlled to output target notes. Then, in response to an interaction operation on the M second virtual objects, the first virtual object is controlled to perform an interaction operation on the M second virtual objects. In this way, after a process in which the N second virtual objects output the target notes is displayed, the first virtual object is controlled to perform an interaction operation on the M second virtual objects, so that an interaction sequence of the first virtual object with the M second virtual objects is associated with a sequence in which the N second virtual objects output the target notes, thereby determining an interaction result based on the interaction sequence of the interaction operation and the output sequence of the target notes. In this way, the interaction result is not only related to the interaction operation, but also related to the interaction sequence of the interaction operation, thereby improving utilization and effectiveness of the interaction operation performed by the first virtual object, and also improving human-computer interaction efficiency and hardware resource utilization of an electronic device.

The following describes an illustrative application of aspects described herein in an actual application scene.

In a related game, a player may be prompted with an audio to beat some particular targets, and a successful beat may be awarded. However, in this technology, beating skills of the player are more tested rather than audio puzzle solving. In addition, this playing method is not friendly to a hearing impairment player.

Based on this, an aspect described herein provides an audio puzzle solving method in a shooting game. In a second virtual space, a player controls a first virtual object to interact with a special scene element (a virtual scene element) in the game, to convert the special scene element into a virtual portal (a transport entrance). The player controls the first virtual object to enter the virtual portal to enter the first virtual space. In the first virtual space, five different types of invincible monsters (second virtual objects) remain in a standing state. Then, the monsters sequentially sing (output target notes). The player needs to remember a singing sequence of the monsters, and shoots the corresponding monsters in the singing sequence after the monsters sing completely.

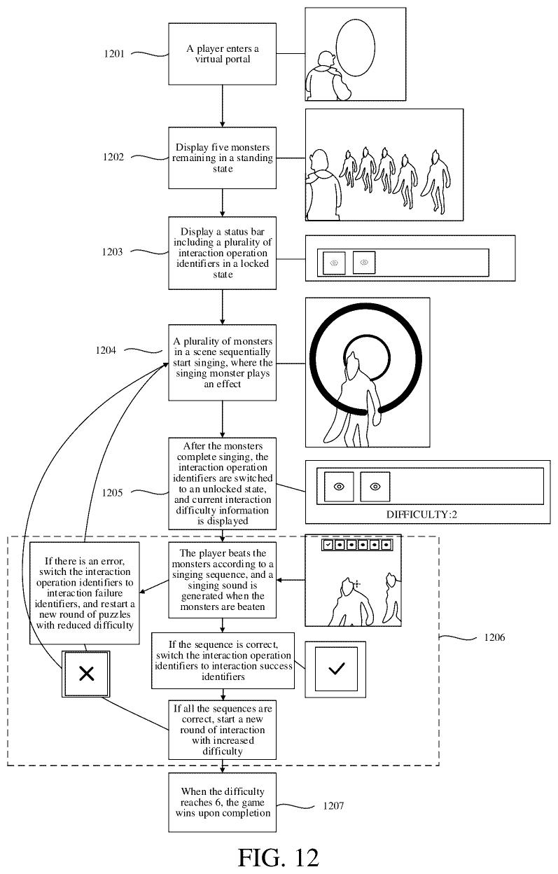

The technical solution described herein is next described below from the product side. Refer to FIG. 12. FIG. 12 is a schematic flowchart of an audio puzzle solving method in a shooting game according to an aspect described herein. Based on FIG. 12, the audio puzzle solving method in a shooting game according to this aspect described herein is implemented by using operation 1201 to operation 1207. Specifically, a player controls a first virtual object to enter a virtual portal to enter a first virtual space. In the first virtual space, five different types of invincible monsters (second virtual objects) remain in a standing state, and a status bar including a plurality of interaction operation identifiers in a locked state is displayed at the same time. Then the monsters sing sequentially (output target notes), effects are played at the same time when the monsters sing. Next, the monster sings completely, the interaction operation identifiers are switched to an unlocked state, and current interaction difficulty information is displayed. Then the player needs to remember a singing sequence of the monsters, and shoots the corresponding monsters in the singing sequence after the monsters sing completely. For an incorrect attack sequence, the interaction operation identifiers are switched to interaction failure identifiers, and a new round of puzzles with reduced difficulty is restarted. When the attack sequence is correct, the interaction operation identifiers are switched to interaction success identifiers. If all the attack sequences are correct, a new round of interaction with increased difficulty is started. When the difficulty reaches the highest difficulty, for example, 6, and all the attack sequences are correct, the game wins.

The monster in the scene is not a real monster, but is an interaction apparatus with a monster model. A singing effect is played during active singing, and a singing sound is made and a beat animation is played after being beaten. Meanwhile, sounds made by the monsters after singing are five scales (C, DEbE, G, A, and C) in the C major Blues scale, and each scale corresponds to each monster. In addition, when the first virtual object controlled by the player enters the first virtual space, a singing difficulty (difficulty prompt information) is displayed. Herein, the singing difficulty may start from 2, the number represents the number of times the monsters sing in a current round, and the difficulty might not exceed 6. When the difficulty falls within 2 to 4, the singing sequence is completely random. When the difficulty falls within 5 to 6, the singing sequence is fixed, and there is a melody.

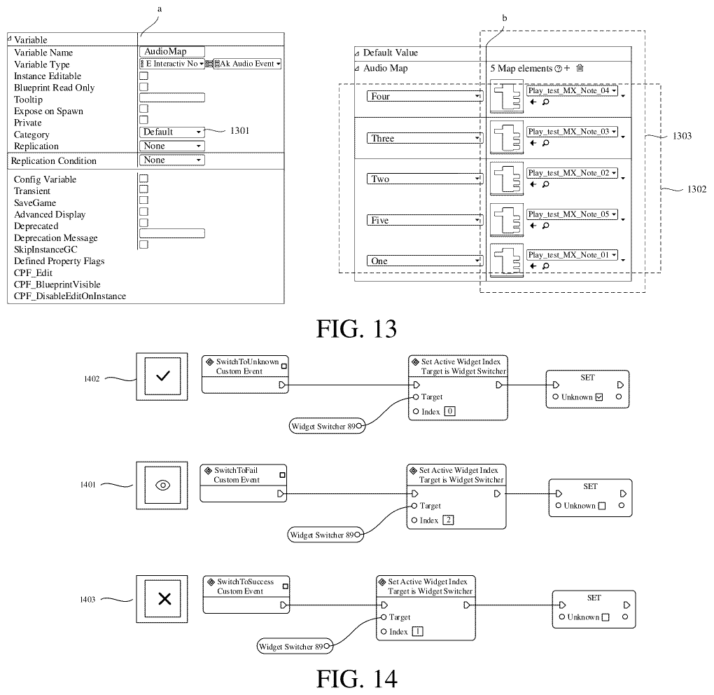

The technical solution described herein is next described below from the technical side. First, refer to FIG. 13. FIG. 13 is a schematic diagram of a singing management setting according to an aspect described herein. Based on FIG. 13, in FIG. a, a singing process of monsters is set. Herein, as shown in 1301, singing notes of the monsters are default notes. For the default notes sung by the monsters, as shown in a dashed box 1302 in FIG. b, notes sung by different monsters are set to be different. Specifically, for five monsters shown in a dashed box 1303 in FIG. b, from top to bottom, the first monster sings note 4, the second monster sings note 3, the third monster sings note 2, the fourth monster sings note 5, and the fifth monster sings note 1.

In an actual implementation, in a first virtual space, a first virtual object has a target quantity of interaction rounds. Each interaction round includes interaction operations on at least two second virtual objects. Difficulty levels corresponding to different interaction rounds are different. When the first virtual object enters the first virtual space, a difficulty level of a current interaction round is obtained based on a level of the first virtual object or a game attribute. Then, notes sung by the monsters and a singing sequence of the monsters are determined based on the difficulty level of the current interaction round, so that the monsters sing sequentially.

In an actual implementation, when an attack operation of the first virtual object on the monsters is received, a singing audio and a beat animation are played, and life values of the second virtual objects further need to be controlled to be restored to maximum life values, namely 100%, so that when the monsters are attacked effectively for multiple times, the monsters do not die. Herein, after the attack operation of the first virtual object on the monsters is received, a beat event interface is further closed. To be specific, a plurality of attack operations on a same monster are not received within a target duration (target completion duration). Specifically, after the first virtual object performs the attack operation on the monsters, if the first virtual object is intended to perform the attack operation on the same monster again, the first virtual object needs to wait for a target duration, namely a cooling duration. After waiting for the cooling duration, the first virtual object can perform the attack operation on the same monster again. During the cooling duration, the first virtual object cannot perform the attack operation again on the same monster.

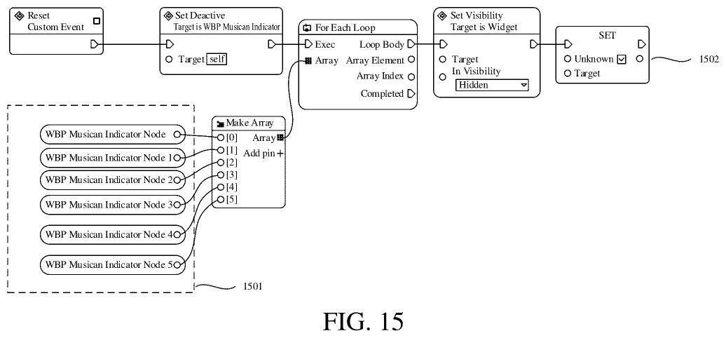

In an actual implementation, a plurality of nested UI components may further be displayed. Refer to FIG. 14. FIG. 14 is a schematic state diagram of a component according to an aspect described herein. Based on FIG. 14, the component has three states in total, namely an unknown state (an interaction operation identifier) indicated by 1401, a success state (an interaction success identifier) indicated by 1402, and a failure state (an interaction failure identifier) indicated by 1403. For each interaction operation, when the interaction operation is not performed yet, the component displays the unknown state based on logic indicated by 1401. When the interaction operation is performed successfully, the component displays the success state based on logic indicated by 1402. When the interaction operation is performed unsuccessfully, the component displays the failure state based on logic indicated by 1403.

In an actual application, refer to FIG. 15. FIG. 15 is a schematic logic diagram of an interaction process according to an aspect described herein. Based on FIG. 15, as indicated by a dashed box 1501, there are six music indicators herein, respectively corresponding to different monsters. When the first virtual object performs each interaction operation such as an attack operation on a plurality of monsters, an interaction result of the first virtual object, namely corresponding notes, is outputted by using the music indicators corresponding to the different monsters. Then, for each interaction operation, when the interaction operation is performed successfully, as shown in 1502, a component corresponding to the interaction operation is displayed with a non-success state.

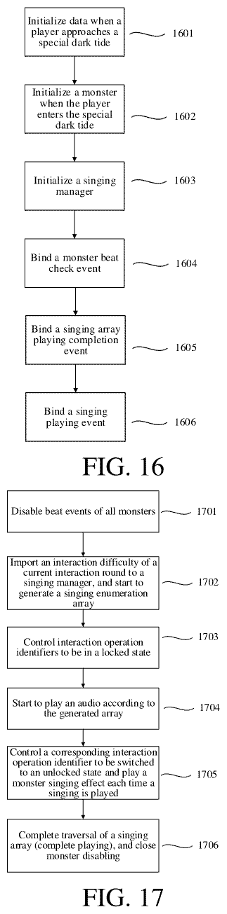

In an actual implementation, for a process of preparing a monster singing process provided described herein, refer to FIG. 16. FIG. 16 is a flowchart of a preparation process of a monster singing process according to an aspect described herein. Based on FIG. 16, the process of preparing a monster singing process according to an aspect described herein is implemented by operation 1601 to operation 1606. Specifically, monsters and a manager are first initialized. Specifically, when a role controlled by a player, namely a first virtual object, approaches an extended dark tide (virtual scene element), internal data of the dark tide is initialized, and the dark tide is controlled to be converted into a transport entrance. For example, when the role of the player approaches the dark tide (a scene element in a game scene, such as a tornado), the dark tide is converted into a portal (namely, the extended dark tide). Then, the player enters a special dark tide, initializes monsters and a singing manager in a first virtual space, and binds a beat check event, a singing playing event, and a singing array playing completion event. Herein, after the singing playing event and the singing array playing completion event are bound, based on the singing playing event, the monsters are controlled to sing sequentially. Herein, refer to FIG. 17. FIG. 17 is a flowchart of a monster singing process according to an aspect described herein. Based on FIG. 17, the monster singing process is implemented according to operation 1701 to operation 1706. Specifically, beat events of all monsters are disabled. To be specific, in the monster singing process, a player cannot attack. Then, an interaction difficulty of a current interaction round is imported to a singing manager, and a singing enumeration array starts to be generated. To be specific, a singing sequence of the monsters is determined. Next, a status bar is displayed, and interaction operation identifiers are controlled to be in a locked state (inactive state). To be specific, the interaction operation identifiers in the locked state are displayed in the status bar. Then, an audio starts to be played according to the generated array. Each time a note is played, the corresponding interaction operation identifier is controlled to be switched to an unlocked state (active state) and a monster singing effect is played. Finally, traversal of the singing array is completed (playing is completed), and monster disabling is closed. To be specific, the player may attack the monsters.

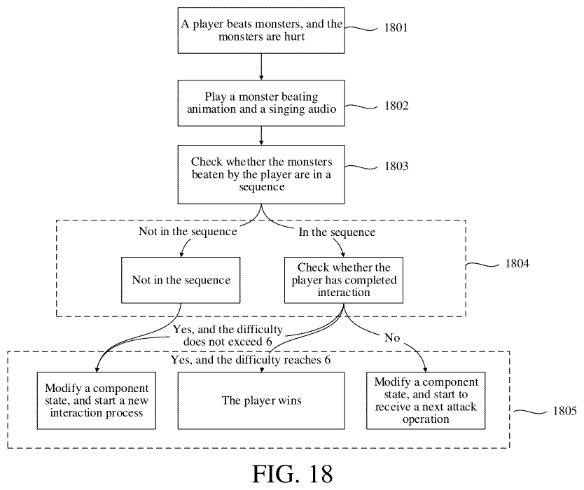

In an actual implementation, for a process of receiving an attack operation performed by a first virtual object on monsters, refer to FIG. 18. FIG. 18 is a flowchart of determining an interaction result of a first virtual object based on an attack operation performed by the first virtual object according to an aspect described herein. Based on FIG. 18, the process of determining an interaction result of a first virtual object is implemented by operation 1801 to operation 1805. Specifically, a player beats monsters. When the monsters are hurt, a monster beating animation and a singing audio are played. Herein, for any attack operation of the player, after the player beats the monsters, there are three states. Specifically, whether the monsters on which a current attack operation of the player is performed are in a sequence. A new interaction process is started in a case that the monsters are not in the sequence, and when the monsters are in the sequence, the player completes the interaction, and the difficulty of the current interaction round does not reach the highest difficulty, for example, 6. It is determined that the player wins when the monsters are in the sequence, the player completes the interaction, and the difficulty of the current interaction round reaches the highest difficulty, for example, 6. A next attack operation performed by the player starts to be received when the monsters are in the sequence and the player does not complete the interaction.

After the player wins, a virtual treasure box (virtual resource) is generated in a level scene, and a virtual portal (transport entrance) is displayed. A player object may exit the first virtual scene through the virtual portal after collecting the virtual treasure box (to be specific, in response to a collection operation on the virtual resource, the virtual resource is collected, and the virtual portal is displayed; and in response to an entry instruction of a first virtual object for the virtual portal, the first virtual object is transported back to a second virtual space). Alternatively, the player may select to continue to control the first virtual object to perform the attack operation on the monsters in an arena, so that the monsters make sounds.

In this way, by means described herein, diversity of playing methods is increased for a player and a better experience of the player is achieved. Not only the memorizing ability of the player is tested, but also the player can complete an interaction process with the help of sight and hearing in the presence of an element of singing. In addition, the player plays a melody while completing the interaction process, so that the player can also be happy to play the melody.

By applying the foregoing aspects described herein, after a first virtual object and M second virtual objects are displayed in a virtual scene, N second virtual objects are controlled to output target notes. Then, in response to an interaction operation on the M second virtual objects, the first virtual object is controlled to perform an interaction operation on the M second virtual objects. In this way, after a process in which the N second virtual objects output the target notes is displayed, the first virtual object is controlled to perform an interaction operation on the M second virtual objects, so that an interaction sequence of the first virtual object with the M second virtual objects is associated with a sequence in which the N second virtual objects output the target notes, thereby determining an interaction result based on the interaction sequence of the interaction operation and the output sequence of the target notes. In this way, the interaction result is not only related to the interaction operation, but also related to the interaction sequence of the interaction operation, thereby improving utilization and effectiveness of the interaction operation performed by the first virtual object, and also improving human-computer interaction efficiency and hardware resource utilization of an electronic device.

The following continues to describe an illustrative structure in which an object interaction apparatus 455 provided in an aspect described herein is implemented as a software module. In some aspects, as shown in FIG. 2, the software module in the object interaction apparatus 455 stored in the memory 450 may include:
a first display module 4551, configured to display a first virtual object and M second virtual objects in a virtual scene, where M is a positive integer greater than 1, the second virtual object is configured for outputting at least one note, and at least some notes outputted by different second virtual objects are different;
a second display module 4552, configured to display a process in which N second virtual objects output target notes, where N is a positive integer and N is less than or equal to M;
a control module 4553, configured to control, in response to an interaction operation on the M second virtual objects, the first virtual object to interact with the M second virtual objects; and
a third display module 4554, configured to display an interaction result of the first virtual object with reference to an output sequence of the target notes and an interaction sequence of the first virtual object with the M second virtual objects.

In some aspects, the second display module 4552 is further configured to: display a stay duration of the first virtual object in the virtual scene; and display, when the stay duration reaches a target stay duration, the process in which the N second virtual objects output the target notes.

In some aspects, the apparatus further includes a fourth display module. The fourth display module is configured to display at least one interaction operation identifier in an inactive state. A quantity of the interaction operation identifiers is configured for indicating a total quantity of target notes outputted by the N second virtual objects. The interaction operation identifiers and the target notes are in a one-to-one correspondence. The interaction operation identifier in the inactive state is configured for indicating that a corresponding target note is not outputted yet.

In some aspects, the apparatus further includes a switching module. The switching module is configured to switch, in the process in which the N virtual objects output the target notes, the interaction operation identifier corresponding to the currently outputted target note from the inactive state to an active state. When the interaction operation identifiers are all in an active state, the quantity of interaction operation identifiers in the active state is configured for indicating a quantity of interaction operations to be performed by the first virtual object with the M second virtual objects.

In some aspects, the apparatus further includes a fifth display module. The fifth display module is configured to display difficulty prompt information. The difficulty prompt information is configured for indicating a difficulty level at which the first virtual object performs the interaction operations.

In some aspects, the apparatus further includes a sixth display module. The sixth display module is configured to display, in a process in which the first virtual object interacts with the M second virtual objects, a process in which the interacted second virtual objects output corresponding target notes.

In some aspects, the apparatus further includes a seventh display module. The seventh display module is configured to display, in the process in which the first virtual object interacts with the M second virtual objects, interaction effects in response to the interaction operations performed by the first virtual object. The interaction effects and the interaction operations are in a one-to-one correspondence.

In some aspects, the third display module 4554 is further configured to: match an execution sequence of the interaction operations performed by the first virtual object with a standard execution sequence, to obtain a matching result, where the standard execution sequence corresponds to the output sequence of the target notes; and display interaction success indication information when the matching result indicates that the execution sequence matches the standard execution sequence, where the interaction success indication information is configured for indicating that the interaction result of the interaction operations performed by the first virtual object is successful.

In some aspects, the first virtual object and the M second virtual objects are displayed in a first virtual space of the virtual scene. The first virtual object is transported from a second virtual space of the virtual scene to the first virtual space. The interaction success indication information is presented by using a transport entrance. The apparatus further includes a transport module. The transport module is configured to control, in response to an entry instruction for the first virtual object, the first virtual object to enter the transport entrance, and transport the first virtual object back to the second virtual space.

In some aspects, the third display module 4554 is further configured to: display interaction failure prompt information when a second virtual object on which the first virtual object performs a current interaction operation does not match a second virtual object on which a current interaction operation indicated by the standard execution sequence is performed, where the interaction failure prompt information is configured for indicating whether to re-control the first virtual object to perform an interaction operation; and redisplay, when a confirmation instruction triggered based on the interaction failure prompt information is received, a process in which at least two second virtual objects output target notes.

In some aspects, the apparatus further includes an eighth display module. The eighth display module is configured to display a virtual resource used as a reward when the interaction result indicates that the interaction sequence of the first virtual object with the M second virtual objects matches the standard execution sequence. The standard execution sequence corresponds to the output sequence of the target notes.

In some aspects, the third display module 4554 is further configured to display, for any interaction operation in a process in which the first virtual object interacts, an interaction success identifier corresponding to the interaction operation when an interaction result of the interaction operation indicates success. The interaction success identifier is configured for indicating that the interaction result of the corresponding interaction operation is success.

In some aspects, in the first virtual space, the first virtual object corresponds to a target quantity of interaction rounds. Each interaction round includes interaction operations on at least two second virtual objects. Difficulty levels corresponding to different interaction rounds are different. The apparatus further includes a first redisplay module. The first redisplay module is configured to display, when the interaction result indicates that an interaction in a current interaction round is successful and a difficulty level corresponding to the current interaction round is less than a highest difficulty level, a process in which K second virtual objects output target notes, so that the first virtual object performs an interaction operation included in a next interaction round. K is a positive integer and K is less than or equal to M. A difficulty level corresponding to the next interaction round is greater than the difficulty level corresponding to the current interaction round.

In some aspects, the apparatus further includes a setting module. The setting module is configured to: display a plurality of different candidate difficulty levels, where different candidate difficulty levels correspond to different virtual resources; set, in response to a selection operation on a target candidate difficulty level among the plurality of candidate difficulty levels, the selected target candidate difficulty level to the highest difficulty level; and display, when the interaction result indicates that an interaction in a current interaction round is successful and a difficulty level corresponding to the current interaction round is equal to the highest difficulty level, a virtual resource that corresponds to the highest difficulty level and is used as a reward.

In some aspects, the apparatus further includes a second redisplay module. The second redisplay module is configured to: obtain, when the interaction result indicates that the current interaction round fails, a difficulty level corresponding to the current interaction round; and redisplay, when the difficulty level is greater than a lowest difficulty level, a process in which P second virtual objects output target notes, so that the first virtual object performs an interaction operation included in a next interaction round. P is a positive integer, P is less than or equal to M, and a difficulty level corresponding to the next interaction round is less than the difficulty level corresponding to the current interaction round.

In some aspects, the first virtual object further has a calling object. The control module 4553 is further configured to control the calling object to cooperate with the first virtual object to interact with the M second virtual objects.

In some aspects, the N second virtual objects include at least one object combination. The object combination includes a second virtual object corresponding to a first note and a second virtual object corresponding to a second note. The first note and the second note form a combined note. The control module 4553 is further configured to control, for each object combination, the first virtual object to perform an interaction operation on the second virtual object corresponding to the first note, and control the calling object to perform an interaction operation on the second virtual object corresponding to the second note.

In some aspects, the apparatus further includes a locking module. The locking module is configured to: control, in response to an aiming instruction for the first virtual object, the first virtual object to aim at the second virtual object corresponding to the second note by using a shooting prop; and control, in the process in which the first virtual object aims at the second virtual object corresponding to the second note by using the shooting prop, the calling object to lock the second virtual object corresponding to the second note. The control module is further configured to: control the first virtual object to perform, by using the shooting prop, an interaction operation on the second virtual object corresponding to the first note; and control the calling object to perform, by using a target skill or a target prop, an interaction operation on the locked second virtual object corresponding to the first note.

In some aspects, the third display module 4554 is further configured to: display, in a process in which the first virtual object interacts, an interaction waiting duration of the first virtual object, where the interaction waiting duration is configured for indicating a time interval between a moment at which the first virtual object completes a previous interaction operation and a moment at which the first virtual object starts to perform a next interaction operation; and display interaction failure prompt information when the interaction waiting duration reaches a target interaction waiting duration, where the interaction failure prompt information is configured for indicating that the interaction result of the corresponding interaction operation is failure.

In some aspects, the first virtual object and the M second virtual objects are displayed in the first virtual space of the virtual scene. The apparatus further includes a conversion module. The conversion module is configured to: display, in the second virtual space of the virtual scene, the first virtual object and a virtual scene element attributable to a natural phenomenon; convert the virtual scene element into a transport entrance when a conversion condition of the virtual scene element is satisfied; and transport the first virtual object from the second virtual space to the first virtual space when the first virtual object is within a sensing region of the transport entrance.

An aspect described herein provides a computer program product or a computer program. The computer program product or the computer program includes computer instructions. The computer instructions are stored in a computer-readable storage medium. A processor of an electronic device reads the computer instructions from the computer-readable storage medium. The processor executes the computer instructions, to cause the electronic device to perform the object interaction method according to the foregoing aspect described herein.

An aspect described herein provides a computer-readable storage medium storing executable instructions. The executable instructions are stored therein. When the executable instructions are executed by a processor, the processor is caused to perform an object interaction method provided in an aspect described herein, for example, the object interaction method shown in FIG. 3.

In some aspects, the computer-readable storage medium may be a read-only memory (ROM), a random access memory (RAM), an erasable programmable read-only memory (EPROM), an electrically erasable programmable read-only memory (EPROM), a flash memory, a magnetic surface memory, an optical disk, a CD-ROM, or another memory. Various devices including one or any combination of the foregoing memories are also possible.

In some aspects, the executable instructions may take the form of program, software, software module, script, or code, may be written in any form of programming language (including compiled or interpreted languages, or declarative or procedural languages), and may be deployed in any form, including as a stand-alone program or as a module, component, subroutine, or another unit suitable for use in a computing environment.

As an example, the executable instructions may, but need not, correspond to files in a file system, and may be stored in a portion of a file that stores other programs or data, for example, in one or more scripts in a hyper text markup language (HTML) document, in a single file dedicated to the program in question, or in a plurality of coordinated files (for example, files that store one or more modules, subroutines, or portions of code).

As an example, the executable instructions may be deployed to be executed on a single electronic device, or on multiple electronic devices located in a single location, or on multiple electronic devices distributed in multiple locations and interconnected through a communication network.

In conclusion, the aspects described herein have the following beneficial effects.
(1) After a process in which N second virtual objects output target notes is displayed, a first virtual object is controlled to perform an interaction operation on M second virtual objects, so that an interaction sequence of the first virtual object with the M second virtual objects is associated with a sequence in which the N second virtual objects output the target notes, thereby determining an interaction result based on the interaction sequence of the interaction operation and the output sequence of the target notes. In this way, the interaction result is not only related to the interaction operation, but also related to the interaction sequence of the interaction operation, thereby improving utilization and effectiveness of the interaction operation performed by the first virtual object, and also improving human-computer interaction efficiency and hardware resource utilization of an electronic device.
(2) Diversity of playing methods is increased for a player and better experience of the player is achieved. Not only the memorizing ability of the player is tested, but also the player can complete an interaction process with the help of sight and hearing in the presence of an element of singing. In addition, the player plays a melody while completing the interaction process, so that the player can also be happy to play the melody.

In the aspects described herein, relevant data such as a user trigger operation is involved. When aspects described herein are applied to a specific product or technology, user permission or consent needs to be obtained, and collection, use, and processing of the relevant data need to comply with relevant laws, regulations, and standards of relevant countries and regions.

The foregoing descriptions are merely aspects described herein and are not intended to limit the protection scope described herein. Any modification, equivalent replacement, or improvement made within the spirit and scope described herein fall within the protection scope described herein.

What is claimed is:

1. A computer-implemented method, comprising:
displaying a first virtual object and M second virtual objects in a virtual scene, where M is a positive integer greater than 1, the second virtual object is configured for outputting at least one note, and wherein at least one note outputted by any two different second virtual objects is different;
displaying a process in which N second virtual objects output target notes, N being a positive integer and N being less than or equal to M, by displaying a different corresponding visual effect for each of the N second virtual objects as its corresponding one or more notes are played;
controlling, in response to an interaction operation on the M second virtual objects, the first virtual object to interact with the M second virtual objects; and
displaying an interaction result of the first virtual object based on a comparison of an output sequence of the target notes and an interaction sequence of the first virtual object with the M second virtual objects.

2. The method according to claim 1, wherein the displaying a process in which N second virtual objects output target notes comprises:
displaying, when a stay duration of the first virtual object in the virtual scene reaches a target stay duration, the process in which the N second virtual objects output the target notes.

3. The method according to claim 1, wherein before the displaying a process in which N second virtual objects output target notes, the method further comprises:
displaying at least one interaction operation identifier in an inactive state,
wherein a quantity of the interaction operation identifiers is configured for indicating a total quantity of target notes outputted by the N second virtual objects, the interaction operation identifiers and the target notes are in a one-to-one correspondence, and the interaction operation identifier in the inactive state is configured for indicating that a corresponding target note is not outputted yet.

4. The method according to claim 3, the method further comprising:
switching, in the process in which the N virtual objects output the target notes, the interaction operation identifier corresponding to the currently outputted target note from the inactive state to an active state,
wherein when the interaction operation identifiers are all in an active state, the quantity of interaction operation identifiers in the active state is configured for indicating a quantity of interaction operations to be performed by the first virtual object with the M second virtual objects.

5. The method of claim 1, wherein after the displaying a first virtual object and M second virtual objects in a virtual scene, the method further comprising:
displaying difficulty prompt information,
wherein the difficulty prompt information is configured for indicating a difficulty level at which the first virtual object performs the interaction operations.

6. The method of claim 1, the method further comprising:
responsive to the first virtual object interacting with the M second virtual objects, outputting each of the M second virtual object's corresponding one or more target notes and displaying a different corresponding visual effect for each of the M second virtual objects as its corresponding one or more notes are played.

7. The method of claim 1, wherein the displaying an interaction result comprises:
matching an execution sequence of the interaction operations performed by the first virtual object with a standard execution sequence, to obtain a matching result,
wherein the standard execution sequence corresponds to the output sequence of the target notes; and
displaying interaction success indication information when the matching result indicates that the execution sequence matches the standard execution sequence, the interaction success indication information being configured for indicating that the interaction result of the interaction operations performed by the first virtual object is successful.

8. The method according to claim 7, wherein the first virtual object and the M second virtual objects are displayed in a first virtual space of the virtual scene, the first virtual object is transported from a second virtual space of the virtual scene to the first virtual space, and the interaction success indication information is presented by using a transport entrance,
the method further comprising:
controlling, in response to an entry instruction for the first virtual object, the first virtual object to enter the transport entrance, and transporting the first virtual object back to the second virtual space.

9. The method according to claim 7, wherein the displaying an interaction result comprises:
displaying interaction failure prompt information when a second virtual object on which the first virtual object performs a current interaction operation does not match a second virtual object on which a current interaction operation indicated by the standard execution sequence is performed,
wherein the interaction failure prompt information is configured for indicating whether to re-control the first virtual object to perform an interaction operation; and
redisplaying, when a confirmation instruction triggered based on the interaction failure prompt information is received, a process in which at least two second virtual objects output target notes.

10. The method of claim 7, further comprising:
displaying a virtual resource used as a reward when the interaction result indicates that the interaction sequence of the first virtual object with the M second virtual objects matches the standard execution sequence.

11. The method of claim 1, wherein the displaying an interaction result comprises:
displaying, for any interaction operation in a process in which the first virtual object interacts, an interaction success identifier corresponding to the interaction operation when an interaction result of the interaction operation indicates success,
wherein the interaction success identifier is configured for indicating that the interaction result of the corresponding interaction operation is success.

12. The method of claim 1, wherein the first virtual object corresponds to a target quantity of interaction rounds, each interaction round comprises interaction operations on at least two second virtual objects, and difficulty levels corresponding to different interaction rounds are different; and
after the displaying the interaction result, the method further comprises:
redisplaying, when the interaction result indicates that an interaction in a current interaction round is successful and a difficulty level corresponding to the current interaction round is less than a highest difficulty level, a process in which K second virtual objects output target notes, so that the first virtual object performs an interaction operation comprised in a next interaction round,
wherein K is a positive integer and K is less than or equal to M; and a difficulty level corresponding to the next interaction round is greater than the difficulty level corresponding to the current interaction round.

13. The method according to claim 12, further comprising:
displaying a plurality of different candidate difficulty levels, different candidate difficulty levels corresponding to different virtual resources;
setting, in response to a selection operation on a target candidate difficulty level among the plurality of candidate difficulty levels, the selected target candidate difficulty level to the highest difficulty level; and
displaying, when the interaction result indicates that an interaction in a current interaction round is successful and a difficulty level corresponding to the current interaction round is equal to the highest difficulty level, a virtual resource that corresponds to the highest difficulty level and is used as a reward.

14. The method according to claim 12, wherein after the displaying an interaction result, the method further comprises:
obtaining, when the interaction result indicates that the current interaction round fails, a difficulty level corresponding to the current interaction round;
redisplaying, when the difficulty level is greater than a lowest difficulty level, a process in which P second virtual objects output target notes, so that the first virtual object performs an interaction operation comprised in a next interaction round,
wherein P is a positive integer, P is less than or equal to M, and a difficulty level corresponding to the next interaction round is less than the difficulty level corresponding to the current interaction round.

15. The method of claim 1, wherein the first virtual object further has a calling object, and the controlling the first virtual object to interact with the M second virtual objects comprises:
controlling the calling object to cooperate with the first virtual object to interact with the M second virtual objects.

16. The method according to claim 15, wherein the N second virtual objects comprise at least one object combination, the object combination comprises a second virtual object corresponding to a first note and a second virtual object corresponding to a second note, and the first note and the second note form a combined note;
the controlling the calling object to cooperate with the first virtual object to interact with the M second virtual objects comprises:
controlling, for each object combination, the first virtual object to perform an interaction operation on the second virtual object corresponding to the first note, and controlling the calling object to perform an interaction operation on the second virtual object corresponding to the second note.

17. The method according to claim 16, wherein before the controlling the first virtual object to perform an interaction operation on the second virtual object corresponding to the first note, the method further comprises:
controlling, in response to an aiming instruction for the first virtual object, the first virtual object to aim at the second virtual object corresponding to the second note by using a shooting prop;
controlling, in the process in which the first virtual object aims at the second virtual object corresponding to the second note by using the shooting prop, the calling object to lock the second virtual object corresponding to the second note;
the controlling the first virtual object to perform an interaction operation on the second virtual object corresponding to the first note, and controlling the calling object to perform an interaction operation on the second virtual object corresponding to the second note comprises:
controlling the first virtual object to perform, by using the shooting prop, an interaction operation on the second virtual object corresponding to the first note; and
controlling the calling object to perform, by using a target skill or a target prop, an interaction operation on the locked second virtual object corresponding to the first note.

18. The method of claim 1, wherein the displaying the interaction result comprises:
displaying, in a process in which the first virtual object interacts, an interaction waiting duration of the first virtual object,
wherein the interaction waiting duration is configured for indicating a time interval between a moment at which the first virtual object completes a previous interaction operation and a moment at which the first virtual object starts to perform a next interaction operation; and
displaying interaction failure prompt information when the interaction waiting duration reaches a target interaction waiting duration,
wherein the interaction failure prompt information is configured for indicating that the interaction result of the corresponding interaction operation is failure.

19. The method of claim 1, wherein the first virtual object and the M second virtual objects are displayed in the first virtual space of the virtual scene, and before the displaying a first virtual object and M second virtual objects in a virtual scene, the method further comprises:
displaying, in the second virtual space of the virtual scene, the first virtual object and a virtual scene element attributable to a natural phenomenon;
converting the virtual scene element into a transport entrance when a conversion condition of the virtual scene element is satisfied; and
transporting the first virtual object from the second virtual space to the first virtual space when the first virtual object is within a sensing region of the transport entrance.

20. A method, comprising:
displaying a virtual scene within a virtual environment, said virtual scene including a player virtual object and a plurality of enemy virtual objects, wherein each enemy virtual object is associated with one or more audio notes, and wherein at least one note differs between the one or more notes associated with any two different enemy virtual objects;
displaying a uniquely different corresponding visual effect for each of one or more of the enemy virtual objects as its corresponding one or more notes are output in a predetermined sequence;
receiving user input for the player virtual object to interact with the plurality of enemy virtual objects in a particular order; and
displaying an interaction result of the player virtual object based on a comparison of an output sequence of the corresponding target notes with the predetermined sequence, based on the particular order in which the player character interacts with the plurality of enemy virtual characters.
